(19) United States
(12) Patent Application Publication
(10) Pub. No.: US 2025/0005876 A1
(43) Pub. Date: Jan. 2, 2025

(54) COMPUTER SYSTEM, VIRTUAL SPACE CONTROL SYSTEM, AND VIRTUAL SPACE CONTROL METHOD

(71) Applicant: BANDAI NAMCO ENTERTAINMENT INC., Tokyo (JP)

(72) Inventors: Takayoshi OI, Suginami-shi (JP); Koji ASUNA, Koto-ku (JP); Kiyoshi MINAMI, Yokohama-shi (JP); Kenichi OGURA, Kodaira-shi (JP); Akio ONDA, Warabi-shi (JP); Takashi AOKI, Funabashi-shi (JP); Shintaro MURAI, Kita-ku (JP)

(73) Assignee: BANDAI NAMCO ENTERTAINMENT INC., Tokyo (JP)

(21) Appl. No.: 18/886,023

(22) Filed: Sep. 16, 2024

Related U.S. Application Data
(63) Continuation of application No. PCT/JP2023/009092, filed on Mar. 9, 2023.

(30) Foreign Application Priority Data
Mar. 30, 2022 (JP) 2022-056821

(51) Int. Cl. G06T 19/20; A63F 13/45; A63F 13/52

(52) U.S. Cl. CPC G06T 19/20; A63F 13/45; A63F 13/52; G06T 2219/024; G06T 2219/2004; G06T 2219/2016

(57) ABSTRACT

A virtual space control system sets a virtual space in a first virtual space, and expresses an embodiment space embodying a second virtual space in the virtual space. Virtual objects embodying embodiment target objects in the second virtual space are disposed in the virtual space. A disposition configuration of the virtual objects in the first virtual space is aligned with a disposition configuration of the embodiment target objects in the second virtual space, which are associated with the virtual objects. captured images serving as sources of embodiment images that undergo texture mapping onto the virtual objects are generated in a sub-server system. The embodiment images are created by causing the captured images to undergo calculation amount reduction processing.

### CROSS REFERENCE TO RELATED APPLICATIONS

This application is a continuation of International Patent Application No. PCT/JP2023/009092, having an international filing date of Mar. 9, 2023, which designated the United States, the entirety of which is incorporated herein by reference. Japanese Patent Application No.2022-056821 filed on Mar. 30, 2022 is also incorporated herein by reference in its entirety.

### BACKGROUND OF THE INVENTION

Such a technique is known that causes a computer to perform a calculation process, constructs a virtual space (for example, a metaverse or a game space), disposes a character (for example, an avatar or a player character) of a user who is also a player, and provides the user a virtual experience in a virtual space. For example, Japanese Unexamined Patent Application Publication No. 2001-312744 discloses a technique allowing users sharing one virtual space to communicate with each other.

When there are a plurality of virtual spaces, there are needs for reproducing a situation of a second virtual space in a first virtual space for providing further enriched virtual experiences in the virtual spaces. When it is possible to reproduce a situation of gameplay of a battle fighting game in another virtual space different from a virtual space where the battle fighting game is played, for example, a user participating in the other virtual space is able to view the situation of gameplay of the battle fighting game, resulting in a further enriched virtual experience.

One possible method for reproducing a situation in another virtual space is a method for executing processing (for example, motion control for character models or game progress control) executed in the other virtual space in a virtual space serving as a destination of reproduction. This method however involves such an issue that there is an extremely high process load in a computer system controlling a virtual space serving as a destination of reproduction. It is therefore difficult to satisfy such needs with a method for simply reproducing a situation of the second virtual space in the first virtual space. It is thus demanded a new embodiment method making a situation where as if the second virtual space exists in the first virtual space.

### BRIEF DESCRIPTION OF THE DRAWINGS

FIG. 1 is a diagram illustrating a configuration example of a virtual space control system.

FIG. 2 is a diagram illustrating control for a second virtual space performed by a sub-server system.

FIG. 3 is a diagram illustrating an example of a second virtual space screen.

FIG. 4 is a diagram illustrating control for a first virtual space performed by a main server system.

FIG. 5 is a diagram illustrating an example of a first virtual space screen.

FIG. 6 is a diagram illustrating an example of a relative positional relationship among the first virtual space, virtual spaces, and embodiment spaces.

FIG. 7 is a diagram illustrating a captured image serving as a source of an embodiment image.

FIG. 8 is a diagram illustrating an example of calculation amount reduction processing.

FIG. 9 is a diagram illustrating an example of disposition of an avatar, a virtual space, and virtual objects in the first virtual space.

FIG. 10 is a block diagram illustrating a functional configuration example of the main server system.

FIG. 11 is a diagram illustrating an example of programs and data that a storage section in the main server system stores.

FIG. 12 is a diagram illustrating a data configuration example of virtual space management data.

FIG. 13 is a diagram illustrating a data configuration example of first virtual space screen display control data.

FIG. 14 is a block diagram illustrating a functional configuration example of the sub-server system.

FIG. 15 is a diagram illustrating a data configuration example of second virtual space control data.

FIG. 16 is a functional block diagram illustrating a functional configuration example of a user terminal.

FIG. 17 is a flowchart illustrating a flow of first virtual space control processing.

FIG. 18 is a flowchart illustrating a flow of first virtual space screen display processing.

FIG. 19 is a flowchart continued from FIG. 18.

FIG. 20 is a flowchart illustrating a flow of processing that the sub-server system executes.

FIG. 21 is a flowchart continued from FIG. 19.

FIG. 22 is a diagram illustrating setting of candidate imaging points of view.

FIG. 23 is a flowchart illustrating a flow of embodiment point-of-view selection processing.

FIG. 24 is a flowchart illustrating a flow of image provision processing.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising at least one processor or circuit programmed to execute:
setting a virtual space for expressing a given embodiment space in a first virtual space; and
disposing an object in the virtual space based on information of an object in a second virtual space, and performing space expression control for expressing the embodiment space embodying the second virtual space.

The “computer system” used herein may be implemented by a single computer, of course, or a plurality of computers in a cooperated manner.

According to the disclosure, in some embodiments, a computer system sets a virtual space in a first virtual space, and performs control for expressing an embodiment space embodying a second virtual space in the virtual space. Since, in the first virtual space, the second virtual space is embodied in a virtual space smaller than the first virtual space, it is possible to suppress an embodiment-related process load. It is therefore possible to provide a technique for a new embodiment method making a situation where as if the second virtual space exists in the first virtual space.

A second disclosure is the computer system, wherein performing the space expression control includes disposing, in the virtual space, an object corresponding to the object in the second virtual space in a disposition configuration based on a disposition configuration in the second virtual space to perform control for expressing the embodiment space.

According to the disclosure, in some embodiments, the computer system is able to dispose, in the virtual space, for embodying an object (an embodiment target object) in the second virtual space, an object corresponding to the object in the second virtual space based on a disposition configuration in the second virtual space.

A third disclosure is the computer system, wherein performing the space expression control includes expressing the second virtual space at a calculation amount smaller than a calculation amount when completely reproducing the second virtual space.

According to the disclosure, in some embodiments, the computer system is able to express the second virtual space at a calculation amount smaller than a calculation amount when completely reproducing the second virtual space.

A fourth disclosure is the computer system, wherein performing the space expression control includes performing control for expressing the embodiment space based on a captured image in which the second virtual space is imaged from a given imaging point of view.

A fifth disclosure is the computer system, wherein performing the space expression control includes:
disposing a virtual object within a field of view of a given user's point of view in the first virtual space; and
performing, based on the user's point of view, rendering processing for rendering the virtual object onto which mapping of an image based on the captured image has been performed.

According to the disclosure, in some embodiments, the computer system is able to perform mapping of a captured image in which the second virtual space is imaged from a given imaging point of view onto the virtual object disposed in the first virtual space to express the embodiment space embodying the second virtual space.

A sixth disclosure is the computer system as defined, wherein performing the space expression control includes performing virtual object control for controlling a position and/or an orientation of the virtual object in accordance with a position and/or an orientation of the user's point of view in the first virtual space.

According to the disclosure, in some embodiments, the computer system is able to control the position and the orientation of the virtual object disposed in the first virtual space in accordance with the position and the orientation of the user's point of view in the first virtual space. For example, it is possible to perform control for causing the virtual object to face the user's point of view, and it is possible to omit control for a virtual object positioning outside a field of view of the user's point of view.

A seventh disclosure is the computer system, wherein performing the virtual object control includes performing control for disposing the virtual object at a posture at which a predetermined relative orientation is taken with respect to the user's point of view to follow a change in position and/or a change in orientation of the user's point of view.

According to the disclosure, in some embodiments, the computer system becomes able to perform, for example, disposition control for causing a predetermined surface (for example, a mapping surface that undergoes texture mapping) of the virtual object to continuously face the user's point of view. A virtual object may be a plate-shaped primitive surface.

An eighth disclosure is the computer system, wherein
the imaging point of view includes a plurality of imaging points of view where disposed positions and/or orientations of disposition in the second virtual space differ from each other, and
performing the space expression control includes performing control for expressing the embodiment space based on a captured image captured from one imaging point of view among the plurality of imaging points of view.

According to the disclosure, in some embodiments, the computer system is able to express an embodiment space based on a captured image captured from one of a plurality of imaging points of view.

A ninth disclosure is the computer system, wherein the at least one processor or circuit is further programmed to execute imaging point-of-view control for controlling a position and/or an orientation of the imaging point of view in the second virtual space in accordance with a position and/or an orientation of the user's point of view in the first virtual space.

A tenth disclosure is the computer system, wherein
performing the space expression control includes expressing the embodiment space by associating a coordinate of the virtual space in the first virtual space and a coordinate of the second virtual space with each other to express the embodiment space in which the second virtual space is fixedly embodied in the virtual space, and
performing the imaging point-of-view control includes controlling the position and/or the orientation of the imaging point of view in the second virtual space to follow a change in position and/or a change in orientation of the user's point of view with respect to the virtual space.

According to the disclosure, in some embodiments, the computer system is able to cause the position and the orientation of the imaging point of view in the second virtual space to respond to a change in position or orientation of the user's point of view in the first virtual space.

Furthermore, according to the disclosure, in some embodiments, it is possible that a captured image is an image in which a participating user in the first virtual space as if stays in and views the second virtual space. It is possible to allow the participating user in the first virtual space to view the second virtual space as if the second virtual space exists at a fixed position in the first virtual space.

An eleventh disclosure is the computer system, wherein performing the space expression control includes disposing, for each of participating users participating in the first virtual space, the user's points of view corresponding to the participating users, performing the rendering processing, and performing control for expressing the embodiment space viewed from each of the user's points of view.

According to the disclosure, in some embodiments, the computer system is able to express an embodiment space viewed from the user's point of view of each participating user in the first virtual space.

A twelfth disclosure is the computer system, wherein
a plurality of the second virtual spaces exist,
setting the virtual space includes setting the virtual space for each of the second virtual spaces in the first virtual space, and
performing the space expression control includes performing, for each of the participating users, the rendering processing for each of the virtual spaces within the field of view of the user's point of view corresponding to each of the participating users.

According to the disclosure, in some embodiments, the computer system is able to set a virtual space corresponding to each of a plurality of second virtual spaces in the first virtual space. When the first virtual space is a site of an exhibition, for example, a virtual space corresponds to each pavilion. A virtual experience that is possible to be provided in the first virtual space is thus further enriched.

A thirteenth disclosure is the computer system, wherein the imaging point of view and a participating user's point of view for each of the users participating in the second virtual space differ from each other.

According to the disclosure, in some embodiments, it is possible to separate, in the first virtual space, the imaging point of view for embodying the second virtual space and the point of view for the participating user participating in the second virtual space from each other.

A fourteenth disclosure is the computer system, wherein the second virtual space is a game space for which game progress is controlled based on an operation input of a user participating in the second virtual space.

According to the disclosure, in some embodiments, the computer system is able to express, in the first virtual space, a situation of a game played across the second virtual space.

A fifteenth disclosure is the computer system, wherein a computer for controlling the first virtual space and a computer for controlling the second virtual space are individually configured and provided.

According to the disclosure, in some embodiments, it is possible to perform processing related to the first virtual space and processing related to the second virtual space in respective computers in a dispersed manner.

A sixteenth disclosure is a virtual space control system comprising:
a server system that is the computer system as defined above; and
a user terminal serving as a man-machine interface for a user participating in the first virtual space.

According to the disclosure, in some embodiments, it is possible to acquire working and effects similar or identical to those according to each of the disclosures described above in a system including a server system and a user terminal serving as a man-machine interface.

In accordance with one of some embodiments, there is provided a virtual space control method executed by a computer system, the virtual space control method comprising:
setting a virtual space for expressing a given embodiment space in a first virtual space; and
disposing an object in the virtual space based on information of an object in a second virtual space, and performing control for expressing the embodiment space embodying the second virtual space.

According to the disclosure, in some embodiments, it is possible to achieve a virtual space control method that makes it possible to provide working and effects similar or identical to those according to the first disclosure.

Exemplary embodiments are described below. Note that the following exemplary embodiments do not in any way limit the scope of the content defined by the claims laid out herein. Note also that all of the elements described in the present embodiment should not necessarily be taken as essential elements.

Hereinafter, examples of the embodiments of the present disclosure are described.

Note that modes to which the present disclosure is applicable are not limited to the following embodiments.

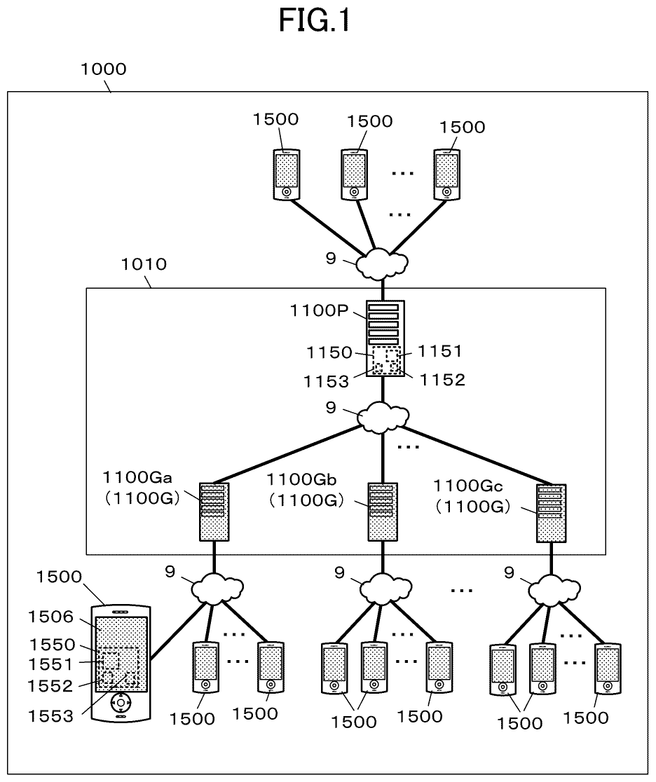

FIG. 1 is a diagram illustrating a configuration example of a virtual space control system 1000.

The virtual space control system 1000 is a system that simultaneously provides a plurality of users virtual experiences in a virtual space. The virtual space control system 1000 is a computer system including an operation server system 1010 and user terminals 1500 (1500a, 1500b, . . . ) each for each of the users, which are coupled to make data communication possible via a network 9. The user terminal 1500 is a man-machine interface (MMIF).

The network 9 means a communication channel that makes data communication possible. That is, the network 9 includes, for example, a telecommunication network, a cable network, or the Internet, in addition to a private line (a private cable) for direct coupling or a local area network (LAN) based on Ethernet (registered trademark).

The operation server system 1010 is a computer system that a service provider or a system operator manages and operates, and includes a main server system 1100P and a plurality of sub-server systems 1100G (1100Ga, 1100Gb, . . . ). The main server system 1100P and the sub-server systems 1100G (1100Ga, 1100Gb, . . . ) are able to perform data communication via the network 9 with each other, and are each able to perform data communication via the network 9 with each of the user terminals 1500.

The main server system 1100P is a computer system controlling and managing a first virtual space, and is a server system to which the user terminals 1500 first access for utilizing various types of services related to the virtual space control system 1000.

The sub-server systems 1100G (1100Ga, 1100Gb, . . . ) each individually control and manage a second virtual space, communicate with one or a plurality of the user terminals 1500, and each function as a game server where the user terminals 1500 serve as game clients.

The main server system 1100P and the sub-server systems 1100G each have basic functions as computers.

That is, the main server system 1100P and the sub-server systems 1100G are each mounted with a main body device, a keyboard, and a touch panel, and a control board 1150 is mounted on the main body device. The control board 1150 is mounted with, for example, a microprocessor that varies in type such as a central processing unit (CPU) 1151, a graphics processing unit (GPU), or a digital signal processor (DSP), an integrated circuit (IC) memory 1152 that varies in type such as a video random access memory (VRAM), a random access memory (RAM), or a read-only memory (ROM), and a communication device 1153. Note that the control board 1150 may be implemented partially or entirely by an application specific integrated circuit (ASIC), a field-programmable gate array (FPGA), or a system on a chip (SoC). However, through a calculation process performed by the control board 1150 based on a predetermined program and data, the main server system 1100P and the sub-server systems 1100G implement functions different from each other.

The main server system 1100P and the sub-server systems 1100G, which are each illustrated as one server device in FIG. 1, may be each implemented by a plurality of devices. For example, the main server system 1100P may be configured such that a plurality of blade servers each taking each function are coupled to each other via an internal bus to make data communication possible. The sub-server systems 1100G each have a similar configuration. Furthermore, installation locations of pieces of hardware forming the main server system 1100P and the sub-server systems 1100G are not limited. Such a configuration may be applied that a plurality of independent servers installed at separate locations are allowed to perform data communication via the network 9 to wholly function as the operation server system 1010.

The user terminal 1500 is a computer system used by each of the users to utilize the virtual space control system 1000. The user terminal 1500 functions as a man-machine interface (MMIF) in the virtual space control system 1000.

The user terminal 1500, which is illustrated as a device called a smartphone in FIG. 1, may each be a computer system such as a wearable computer, a portable game device, a consumer game device, a tablet computer, a personal computer, or a stand-alone type virtual reality (VR) headset, for example. When a plurality of electronic devices, such as a combination of a smartphone, a smartwatch capable of establishing a communication connection with the smartphone, and an optional type VR headset, for example, are communicably coupled to each other to implement a single function, the plurality of electronic devices may be considered as a single user terminal 1500.

The user terminal 1500 includes an operation input device (for example, a touch panel 1506, a keyboard, a game controller, or a mouse), an image display device (for example, the touch panel 1506, a head-mounted display, or a glasses type display), and a control board 1550.

The control board 1550 includes, for example, a CPU 1551, a microprocessor that varies in type such as a GPU or a DSP, an IC memory 1552 that varies in type such as a VRAM, a RAM, or a ROM, and a communication module 1553 coupled to the network 9. These elements mounted on the control board 1550 are electrically coupled to each other via a bus circuit, for example, and are thus coupled to make reading of a piece of data and transmission and reception of a signal possible. The control board 1550 may be partially or entirely implemented by an ASIC, an FPGA, or an SoC. The control board 1550 then causes the IC memory 1552 to store programs and various types of data for implementing a function as the user terminal. The user terminal 1500 then executes a predetermined application program to implement a function as the man-machine interface (MMIF) for the virtual space control system 1000.

The user terminal 1500, which is configured to download the application program and various types of data necessary for executing the application program from the main server system 1100P and the sub-server systems 1100G, may be configured to read the application program and various types of data necessary for executing the application program from a storage medium such as a memory card that each of the users acquires separately.

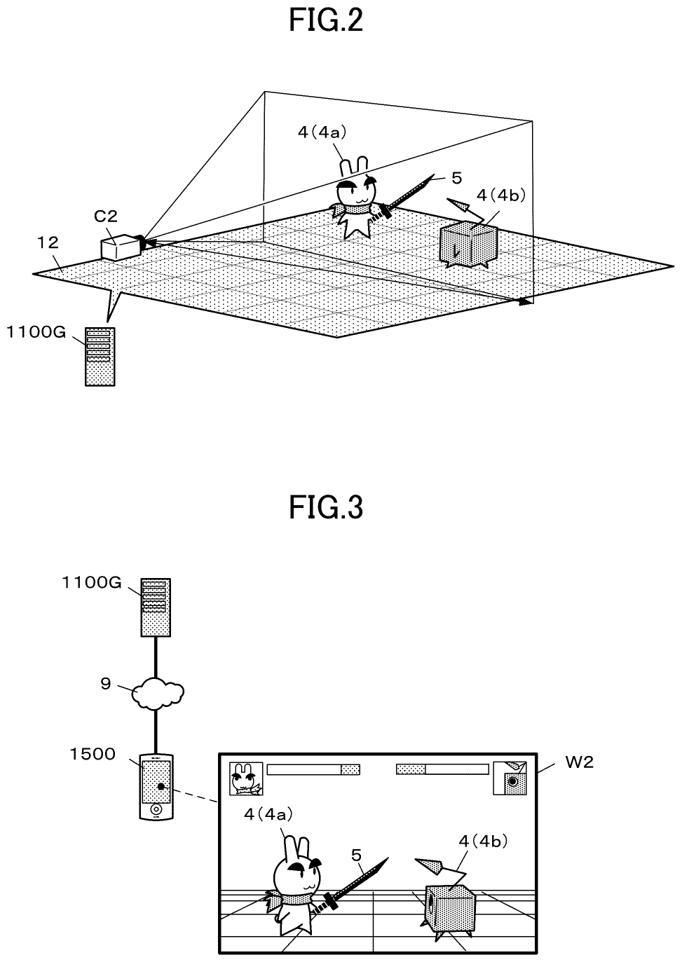

FIG. 2 is a diagram illustrating control for a second virtual space 12 by each of the sub-server systems 1100G. The sub-server system 1100G is a computer system for controlling the second virtual space 12 that is a three-dimensional virtual space, holding data related to the second virtual space 12, and controlling a disposition configuration of various types of objects disposed in the second virtual space 12. The sub-server system 1100G then uses the objects to implement an online game.

That is, the second virtual space 12 is a game space in which game progress is controlled based on an operation input performed by the user participating in the second virtual space 12 (hereinafter referred to as a “second participating user”). The sub-server system 1100G treats the user who has play-logged in as a player, disposes a player character 4 in the second virtual space 12, and controls motion of the player character 4 in accordance with an operation input detected in the user terminal 1500 of the user. Furthermore, a non-player character (NPC) is automatically controlled. That is, the sub-server system 1100G functions as a game server for a client-server type system, and provides the second participating user operating the user terminal 1500 serving as a game client a virtual experience in the online game.

In the example illustrated in FIG. 2, the sub-server system 1100G implements the online game that is a fighting battle game where two player characters 4 (4a and 4b) each for each of the second participating users fight one-to-one. Although an illustration of a background object is omitted for purposes of convenience, a size of the second virtual space 12 is actually far larger than that in the example illustrated in FIG. 2, and various types of background objects form a fighting field.

Note that a game genre of an online game that the sub-server system 1100G implements is not limited to a fighting battle game, and it is possible to set a desired game genre as appropriate. For example, the game genre may be a multiplayer online role playing game (MORPG), a racing game, a sport game such as soccer or baseball, or a strategy simulation game. Furthermore, it is not limited to an online game, and may be a virtual live concert or a caring game, for example.

In the second virtual space 12, a participating user's point of view C2, which is an imaging point of view for the second participating user, is set, and an image of the second virtual space 12 (a virtual space image), which is captured from the participating user's point of view C2, is rendered. A game screen that is added, as appropriate, with information display for gameplay on the virtual space image, is then generated. The game screen is, as illustrated in FIG. 3, displayed as a second virtual space screen W2 on the user terminal 1500 of the second participating user.

It is possible to set, as appropriate, the participating user's point of view C2 in accordance with a game genre. Since it is a game screen for the fighting battle game in the example illustrated in FIG. 3, a position and a line-of-sight direction of the participating user's point of view C2 are automatically controlled to maintain a screen layout where the player characters 4 (4a and 4b) are viewed from a side, and where the single participating user's point of view C2 is set and shared by the second participating users fighting each other. When the game genre is an MORPG, the participating user's points of view C2 are prepared separately for each second participating user. To make the player character 4 for the user a main object, or to implement a field of view of the player character 4 of the user, a disposed position and an orientation of disposition (a posture; a line-of-sight direction) are then automatically controlled.

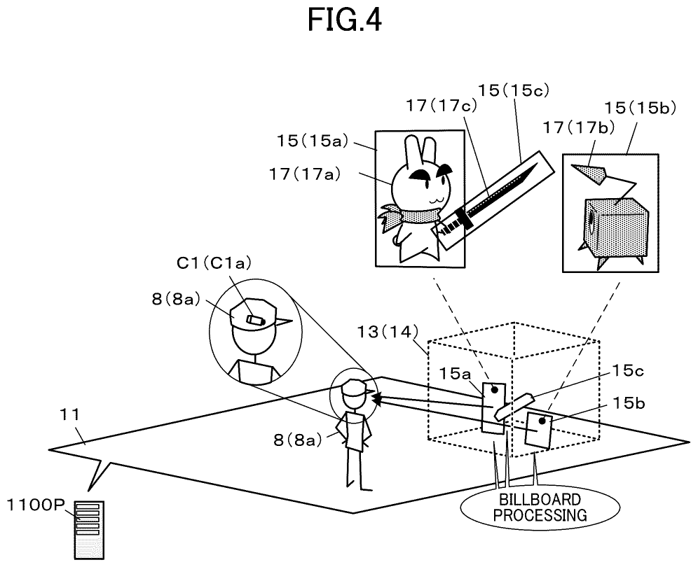

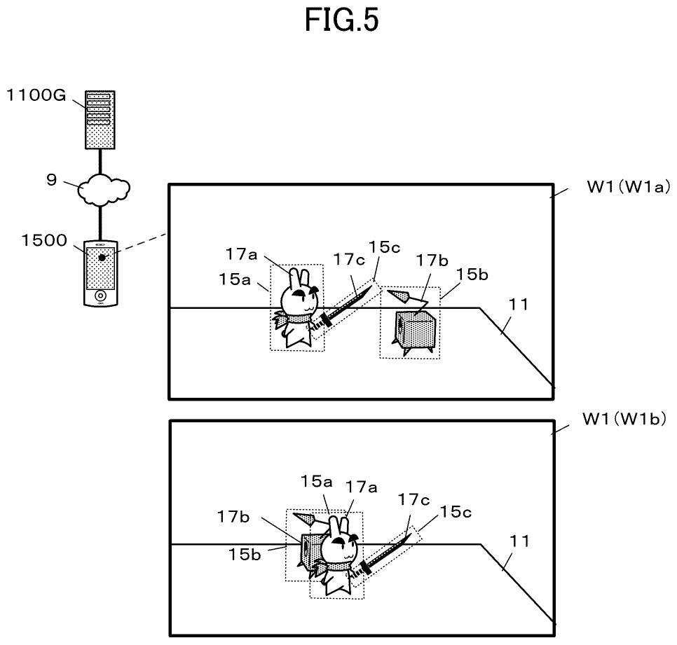

FIG. 4 is a diagram illustrating control for a first virtual space 11 by the main server system 1100P. The main server system 1100P holds data related to the first virtual space 11 that is a three-dimensional virtual space, and controls a disposition configuration of various types of objects disposed in the first virtual space 11. The main server system 1100P then uses the objects to create a world of the first virtual space 11, and disposes an avatar 8 for each first participating user.

The main server system 1100P controls, in accordance with various types of operations that the first participating user has inputted to the user terminal 1500, movement and motion of the corresponding avatar 8.

A user's point of view C1 for the first participating user using the avatar 8 is set at a predetermined position on a head of the avatar 8. As the avatar 8 is moved, and a posture of the avatar 8 is changed, the user's point of view C1 is also moved in a linked manner, and its line-of-sight direction (the orientation of the field of view) is changed.

The main server system 1100P renders a situation of the first virtual space 11 imaged from the user's point of view C1 for each avatar 8 (for each first participating user) (rendering processing). An image illustrating the situation of the first virtual space 11 that the avatar 8 views, that is, a first virtual space screen W1, as illustrated in FIG. 5, is then displayed on the user terminal 1500 of the user of the avatar 8.

When it is assumed that the first virtual space 11 correspond to a metaverse, the first participating user is able to enjoy a pseudo-life type virtual experience resembling a real life.

As one of features of the present embodiment, one or a plurality of virtual spaces 13 are prepared in the first virtual space 11, as illustrated in FIG. 4. The virtual space 13 is also referred to as an embodiment space 14 for embodying at least a part of the second virtual space 12 (see FIG. 2). A coordinate system for the first virtual space 11, in which an embodiment space 14 is set, and a coordinate system for the second virtual space 12 are transformable with each other by using a predetermined coordinate transformation matrix, and both are basically in a fixed relationship. However, there is no limitation in such relationship when an embodiment space 14 is desired to be moved in the first virtual space 11.

It is possible to set, as appropriate, a total number of virtual spaces 13 set in the first virtual space 11, or a position, a shape, or a size of each of the virtual spaces 13 in the first virtual space 11.

It is possible to set, as appropriate, a total number of embodiment spaces 14 set in each of the virtual spaces 13, or a position, a shape, or a size of each of the embodiment spaces 14 in the first virtual space 11.

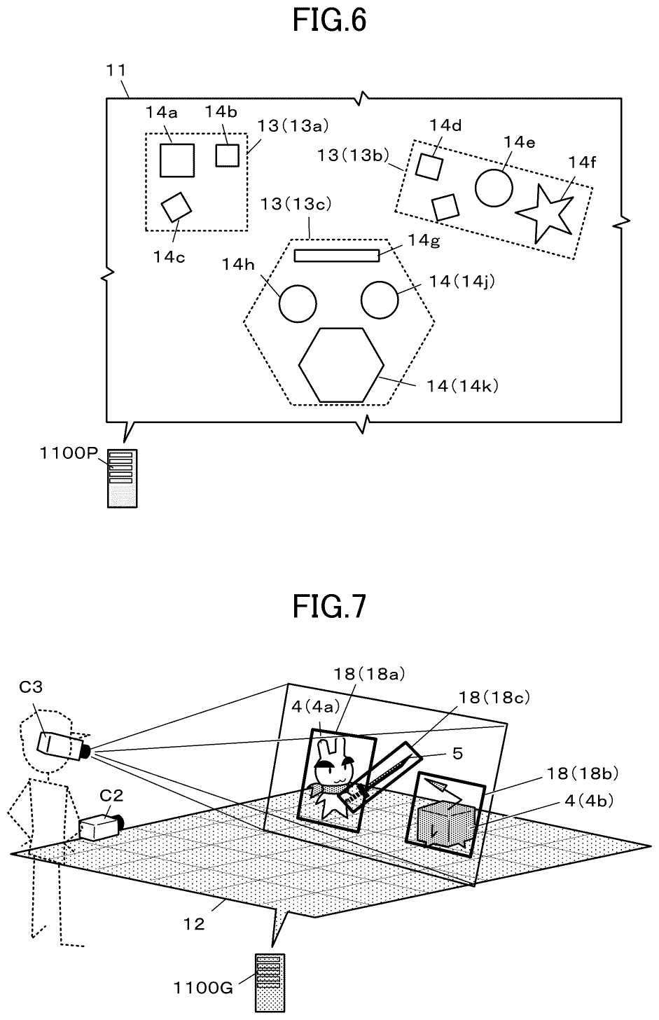

FIG. 4 illustrates an example where one embodiment space 14 is associated with one virtual space 13. However, the present disclosure is not limited to this example. For example, FIG. 6 is a schematic diagram where a part of the first virtual space 11 is viewed from above (an illustration of an avatar 8 is omitted), and illustrates an example where a plurality of virtual spaces 13 (13a, 13b, . . . ) are set in the first virtual space 11, and a plurality of embodiment spaces 14 (14a, 14b, . . . ) are set in one of the virtual spaces 13. When it is assumed that the first virtual space 11 is a site of an international exposition, it may be said that a virtual space 13 corresponds to a pavilion under one theme, which is installed in the site of the international exposition, and an embodiment space 14 corresponds to a booth under one detailed theme, which is provided in one pavilion.

Now back to FIG. 4, one or a plurality of virtual objects 15 are disposed in an associated manner for the user's point of view C1 in the embodiment space 14. Although, in the example illustrated in FIG. 4, one avatar 8 and one user's point of view C1, and three virtual objects 15 (15a, 15b, and 15c) associated with the avatar 8 are only illustrated, a plurality of avatars 8 and a plurality of user's points of view C1 may exist for each first participating user in actual implementation. One or a plurality of virtual objects 15 are then prepared for each of the plurality of avatars 8 and the plurality of user's points of view C1.

A virtual object 15 is an object having a simple shape where there is a smaller number of component polygons. For example, it is possible to form a virtual object with a primitive surface, or a virtual object may be formed with one plate-shaped polygon.

Each virtual object 15 is associated with one embodiment target object (an object that is a target to be embodied) in the second virtual space 12 (a virtual space that is a target to be embodied) associated with its embodiment space 14.

An “embodiment target object” refers to, when a thing in the second virtual space 12 is to be embodied in the first virtual space 11, an object selected from among various types of objects disposed in the second virtual space 12. Since the fighting battle game undergoes progress control in the second virtual space 12, player characters 4 (4a and 4b) and an item 5 that the player character 4a holds in the second virtual space 12 serve as embodiment target objects. Virtual objects 15 (15a, 15b, and 15c) corresponding to the embodiment target objects are then disposed in the first virtual space 11.

The virtual objects 15 undergo posture control to cause their mapping surfaces to undergo texture mapping of embodiment images 17 (17a, 17b, and 17c) that are images of the corresponding embodiment target objects to cause a normal direction of each of the mapping surfaces to be directed to the corresponding user's point of view C1. The virtual objects 15 therefore each undergo posture control to have a predetermined relative orientation with respect to the line-of-sight direction of the user's point of view C1. So-called billboard processing is thus executed. Furthermore, a disposition configuration of the virtual objects 15 in the virtual space 13 undergoes link control with respect to a disposition configuration of the corresponding embodiment target objects in the second virtual space 12.

FIG. 7 is a diagram illustrating a captured image serving as a source of an embodiment image 17.

The main server system 1100P requests, when a new embodiment space 14 enters within the field of view of the user's point of view C1 of the avatar 8, the sub-server system 1100G managing the second virtual space 12 corresponding to the embodiment space 14 for setting an embodiment point of view C3 corresponds to the user's point of view C1 of the avatar 8.

The embodiment point of view C3 is an imaging point of view when capturing a captured image serving as a source of an embodiment image 17. The embodiment point of view C3 is a point of view at which the line-of-sight direction of the user's point of view C1 is copied at the position of the user's point of view C1 when the avatar 8 is assumed to exist in the second virtual space 12. As the avatar 8 moves in the first virtual space 11 or changes the line-of-sight direction, the corresponding embodiment point of view C3 is then controlled in a linked manner to change the position in the second virtual space 12 or to change the line-of-sight direction.

Specifically, the position and the line-of-sight direction of the embodiment point of view C3 are set by converting the position and the line-of-sight direction of the user's point of view C1 of the corresponding avatar 8 based on a coordinate transformation matrix between the coordinate system for the first virtual space 11 and the coordinate system for the second virtual space 12. Note that an imaging angle of view of the embodiment point of view C3 is set identically or substantially identically to that of the user's point of view C1 of the corresponding avatar 8.

The sub-server system 1100G generates captured images 18 (18a, 18b, and 18c) for each of the embodiment target objects in the second virtual space 12, which are associated with the virtual objects 15, from the embodiment point of view C3.

The captured images 18, which are each illustrated in a rectangular with a thick line in FIG. 7 to facilitate understandings, are each an image in which an object serving as a capturing target is only rendered in fact.

For example, the captured image 18a of the player character 4a that is the embodiment target object is created by rendering only its character when the player character 4a is imaged from the embodiment point of view C3. No background is rendered. Otherwise, the captured image 18a may be created by first rendering a whole field-of-view image of the embodiment point of view C3, and then cutting only a part where the player character 4a is rendered from the whole field-of-view image. The captured image 18b of the player character 4b and the captured image 18c of the item 5 are also created in a similar manner. Note that, when the item 5 is held by or is in contact with the player character 4a, both the item 5 and the player character 4a may be considered as one virtual object 15, and may be treated as one captured image 18.

These captured images 18 (18a, 18b, and 18c) are not images for the online game. Additional processing is therefore necessary for the sub-server system 1100G for embodying the second virtual space 12. However, the embodiment target objects serving as rendering targets are only some of all the objects in the second virtual space 12, resulting in a far smaller process load along with rendering of the captured images 18 than that when all the objects are rendered.

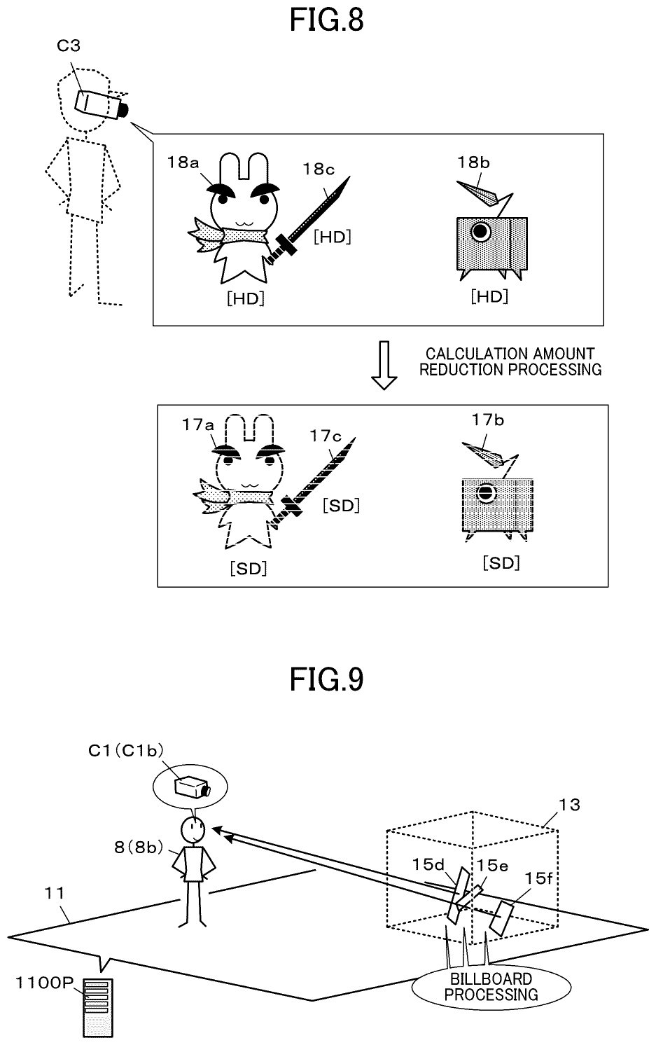

As the captured images 18 based on the embodiment point of view C3 are generated, the sub-server system 1100G transmits their pieces of data to the main server system 1100P. The main server system 1100P performs, as illustrated in FIG. 8, calculation amount reduction processing on the received captured images 18 to create the embodiment images 17.

The “calculation amount reduction processing” is processing for reducing a calculation amount that is necessary when generating a first virtual space screen W1, and refers to, for example, image quality reduction processing for lowering image quality from high definition (HD) image quality to standard definition (SD) image quality (for example, reducing a number of colors or reducing a resolution). Texture mapping of the embodiment images 17 is then performed on the virtual objects 15.

Now back to FIG. 4, a size and a shape of each of the virtual objects 15 for which mapping of the embodiment images 17 is performed are set to accommodate each of the embodiment images 17 of the corresponding embodiment target objects.

The size and the shape of each of the virtual objects 15 may be acquired, for example, as a rectangular having an upper-lower width and a left-right width identical to an upper-lower width and a left-right width of each of the embodiment images 17 (otherwise, a slightly larger rectangular). Otherwise, the size and the shape of each of the virtual objects 15 may be acquired by projecting a boundary box used for contact determination of the object of the player character 4 onto a normal surface of the embodiment point of view C3 (a surface on which the line-of-sight direction serves as a normal line).

As a result, a situation of the corresponding second virtual space 12 is embodied in the embodiment space 14 in the virtual space 13, which has entered the field of view of the avatar 8 (8a) in the first virtual space screen W1 (W1a and W1b) (see FIG. 5). A process load that is necessary for an embodiment purpose in the operation server system 1010 is thus suppressed, compared with a case where the second virtual space 12 is completely reproduced (in a case where all objects disposed in the second virtual space 12 are to be replicated and disposed in the first virtual space 11).

In particular, the virtual objects 15 (15a, 15b, and 15c) are formed by performing texture mapping of the embodiment images 17 (17a, 17b, and 17c) onto plate-shaped polygons, resulting in an extremely low calculation amount.

As the player character 4a, the player character 4b, and the item 5 move in the second virtual space 12, the virtual objects 15 (15a, 15b, and 15c) also change in position in a linked manner.

Control for expressing an embodiment space 14 embodying the second virtual space 12 in the first virtual space 11 is set for each avatar 8.

When the avatar 8b that differs from the avatar 8a (see FIG. 4) is disposed in the first virtual space 11, for example, as illustrated in FIG. 9, virtual objects 15 (15d, 15e, and 15f) for the avatar 8b are prepared, and billboard processing is performed toward a user's point of view C1b of the avatar 8b. For the embodiment images 17 with which texture mapping is performed onto these virtual objects 15, similar to those described previously, an embodiment point of view corresponding to a user's point of view C1b of the avatar 8b is set in the second virtual space 12. A disposed position and/or an orientation of disposition of an embodiment point of view of the avatar 8b in the second virtual space 12 basically differ(s) from those of the imaging point of view for the avatar 8a. The embodiment image 17 for the avatar 8b is then created based on the captured image 18 of the second virtual space 12, which is captured from the embodiment point of view for the avatar 8b.

When a first virtual space screen W1 for the avatar 8b is to be generated, the virtual objects 15 (15a, 15b, and 15c) for the avatar 8a are once excluded from rendering targets (rendering OFF), and are then rendered as images of the first virtual space 11 imaged from the user's point of view C1b. When a first virtual space screen W1 for the avatar 8a is to be generated, on the other hand, the virtual objects 15 (15d, 15e, and 15f) for the avatar 8b are once excluded from rendering targets (rendering OFF), and are then rendered as images of the first virtual space 11 imaged from the user's point of view C1a.

The main server system 1100P is thus able to allow a situation of the second virtual space 12 to be embodied in the first virtual space 11 without artificiality when viewed from all the avatars 8 in the first virtual space 11.

Next, a functional configuration will now be described herein.

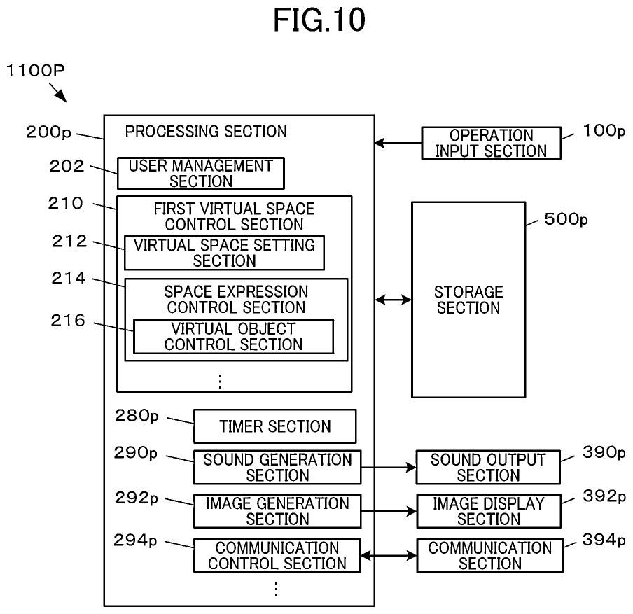

FIG. 10 is a block diagram illustrating a functional configuration example of the main server system 1100P.

The main server system 1100P includes an operation input section 100p, a processing section 200p, a sound output section 390p, an image display section 392p, a communication section 394p, and a storage section 500p.

The operation input section 100p is a means for inputting various types of operations for managing the main server system 1100P. For example, the operation input section 100p corresponds to a keyboard, a touch panel, or a mouse.

The processing section 200p is implemented, for example, by a processor serving as a calculation circuit such as a CPU, a GPU, an ASIC, or an FPGA and an electronic component such as an IC memory, and performs input-and-output control for data among functional sections including the operation input section 100p and the storage section 500p. Various types of calculation processes are then executed based on a predetermined program and data, an operation input signal from the operation input section 100p, or data received from the user terminals 1500 and the sub-server systems 1100G (1100Ga, 1100Gb, . . . ), for example, to comprehensively control operation of the main server system 1100P.

The processing section 200p includes a user management section 202, a first virtual space control section 210, a timer section 280p, a sound generation section 290p, an image generation section 292p, and a communication control section 294p. Other functional sections may be included as appropriate, of course.

The user management section 202 performs processing related to a user registration procedure, storage management of various types of information associated with a user account, or processing for system login or system logout.

The first virtual space control section 210 performs various types of control related to the first virtual space 11.

The first virtual space control section 210 includes a virtual space setting section 212 and a space expression control section 214.

The virtual space setting section 212 sets a virtual space 13 for expressing an embodiment space 14 in the first virtual space 11. When a plurality of second virtual spaces 12 exist, the virtual space setting section 212 sets a virtual space 13 for each of the second virtual space 12 in the first virtual space 11.

The space expression control section 214 disposes an object in the virtual space 13 based on information of an object in the second virtual space 12, and performs control for expressing an embodiment space 14 embodying the second virtual space 12 based on a captured image 18 in which the second virtual space 12 is imaged from a given imaging point of view (the embodiment point of view C3 illustrated in FIG. 7).

Specifically, the space expression control section 214 expresses the embodiment space 14 by associating a coordinate of the virtual space 13 in the first virtual space 11 and a coordinate of the second virtual space 12 with each other to express the embodiment space 14 in which the second virtual space 12 is fixedly embodied in the virtual space 13. The space expression control section 214 then disposes, for each participating user participating in the first virtual space 11, the user's point of view C1 corresponding to the participating user. The space expression control section 214 then performs rendering processing on each of the virtual spaces 13 within the field of view of the user's point of view C1 corresponding to the participating user to perform control for expressing the embodiment space 14 viewed from each user's point of view.

Furthermore, the space expression control section 214 disposes virtual objects 15 corresponding to objects in the second virtual space 12 in a disposition configuration based on a disposition configuration in the second virtual space 12 to perform control for expressing an embodiment space. Specifically, the space expression control section 214 disposes the virtual objects 15 within the field of view of the user's point of view C1 in the first virtual space 11. The space expression control section 214 then performs rendering processing for rendering the virtual objects 15 onto which mapping of the images (the embodiment images 17 illustrated in FIG. 4) based on the captured images 18 is performed based on the user's point of view C1 to perform control for expressing embodiment spaces.

The space expression control section 214 includes a virtual object control section 216.

The virtual object control section 216 controls a position and/or an orientation of each of the virtual objects 15 in accordance with the position and/or the orientation of the user's point of view C1 in the first virtual space 11. Specifically, the virtual object control section 216 performs control for disposing each of the virtual objects 15 in a posture at a predetermined relative orientation with respect to the user's point of view C1 to follow a change in position and/or a change in orientation of the user's point of view C1. The billboard processing onto each of the virtual objects 15 corresponds to the processing described above (see FIG. 4).

The timer section 280p utilizes a system clock to perform various types of time measurements such as a current date and time or a limited time period.

The sound generation section 290p is implemented by an IC or through execution of software that generates sound data or performs decoding. The sound generation section 290p outputs a generated sound signal to the sound output section 390p. The sound output section 390p is implemented by a speaker, for example, and emits sound based on the sound signal.

The image generation section 292p generates images of various types of management screens for system management of the main server system 1100P, and outputs image data to the image display section 392p. The image display section 392p is implemented by a flat panel display, a head-mounted display, or a projector, for example.

The communication control section 294p executes data processing related to data communication, and implements data exchange with an external device via the communication section 394p. The communication section 394p is coupled to the network 9 to implement communication. For example, the communication section 394p is implemented by a wireless communication device, a modem, a terminal adaptor (TA), a jack for wired communication cable, or a control circuit. In the example illustrated in FIG. 1, the communication device 1153 corresponds to the communication section 394p.

The storage section 500p stores programs and various types of data for implementing various types of functions for causing the processing section 200p to comprehensively control the main server system 1100P. The storage section 500p is used as a work area for the processing section 200p, and temporarily stores, for example, results of calculations executed by the processing section 200p in accordance with the various types of programs. This function is implemented, for example, by an IC memory such as a RAM or a ROM, a magnetic disc such as a hard disk, an optical disc such as a compact disc read-only memory (CD-ROM) or a digital versatile disc (DVD), or an online storage. In the example illustrated in FIG. 1, the IC memory 1152 mounted on the main body device or a storage medium such as a hard disk corresponds to the function. An online storage may be included in the storage section 500p.

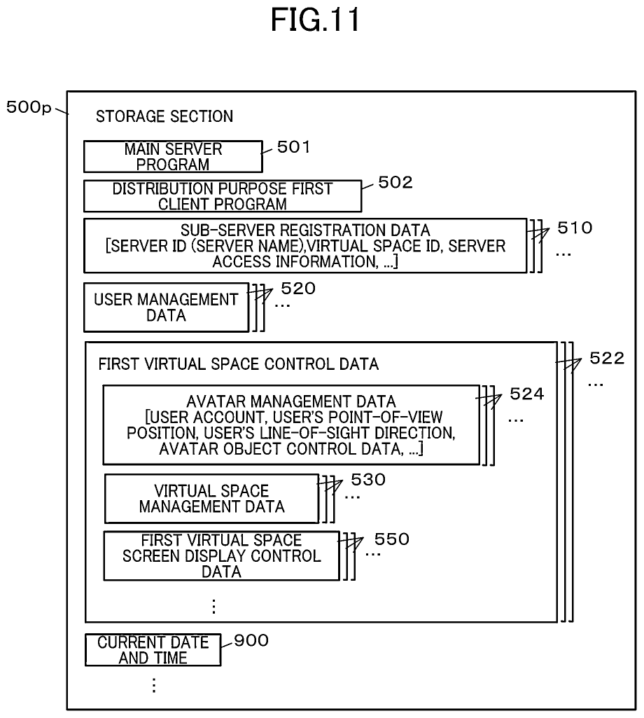

FIG. 11 is a diagram illustrating an example of programs and data that the storage section 500p in the main server system 1100P stores.

The storage section 500p stores a main server program 501, a distribution purpose first client program 502, sub-server registration data 510, user management data 520, first virtual space control data 522, and a current date and time 900. Note that the storage section 500p stores other programs and data (for example, a timer, a counter, or various types of flags) as appropriate.

The main server program 501 is a program read and executed by the processing section 200p to cause the main server system 1100P to function as the user management section 202 or the first virtual space control section 210, for example.

The distribution purpose first client program 502 is an application program provided to and executed by the user terminals 1500, and is an original of a client program for utilizing the first virtual space 11.

The sub-server registration data 510 is prepared for each of the sub-server systems 1100G. The sub-server registration data 510 includes a unique server ID, a virtual space ID uniquely set to the second virtual space 12 managed by the sub-server system 1100G, and server access information that is necessary for coupling to the sub-server system 1100G to make data communication possible. Other types of data may be included as appropriate, of course.

The user management data 520 is prepared for each user having undergone a registration procedure, stores various types of data related to the user, and is managed by the user management section 202. One piece of the user management data 520 includes, for example, a user account unique to the user, game saving data, and participation history data (for example, dates and times of login and logout). Other types of data may be included as appropriate, of course.

The first virtual space control data 522 stores various types of data related to control of the first virtual space 11. For example, the first virtual space control data 522 stores avatar management data 524 for each avatar 8, virtual space management data 530, and first virtual space screen display control data 550.

The avatar management data 524 includes, for example, a user account indicating a first participating user using the avatar 8, a user's point-of-view position and a user's line-of-sight direction of the user's point of view C1 of the avatar 8, and avatar object control data for controlling an object of the avatar 8.

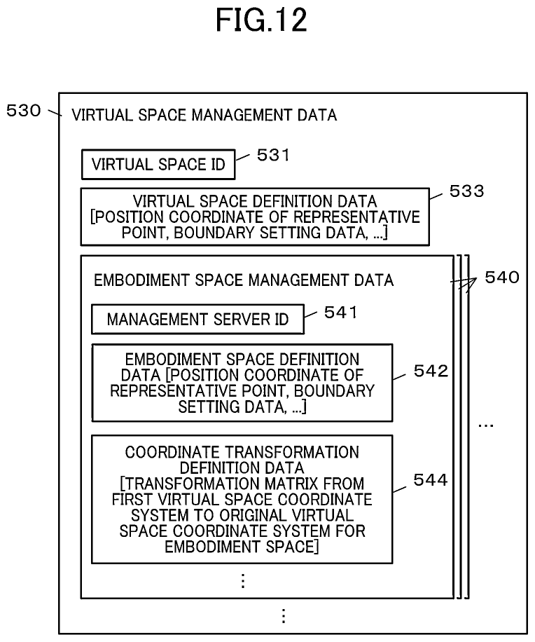

The virtual space management data 530 is created for each virtual space 13, and stores various types of data related to the virtual space 13. One piece of the virtual space management data 530 stores, for example, as illustrated in FIG. 12, a virtual space ID 531, virtual space definition data 533, and embodiment space management data 540 created for each embodiment space 14 set in the virtual space 13. Other types of data may be included as appropriate, of course.

The virtual space definition data 533 indicates a location and a shape of the virtual space 13 set in the first virtual space 11. For example, a position coordinate of a representative point in the virtual space 13 in a first virtual space coordinate system, and boundary setting data for setting a boundary of the virtual space 13 (for example, a coordinate of each top on a contour of the boundary) are included.

One piece of the embodiment space management data 540 includes a management server ID 541, embodiment space definition data 542, and coordinate transformation definition data 544.

The management server ID 541 indicates the sub-server system 1100G controlling and managing the second virtual space 12 embodied in the embodiment space 14.

The embodiment space definition data 542 indicates a location and a shape of the embodiment space 14 set in the virtual space 13. For example, data defining a position and a size of the embodiment space 14 in the first virtual space 11 (for example, a position coordinate of a representative point or boundary setting data) is included.

The coordinate transformation definition data 544 indicates a transformation matrix from a coordinate system for the first virtual space 11 where the embodiment space 14 exists (the first virtual space coordinate system) to a coordinate system for the second virtual space 12 embodied in the embodiment space 14 (an original virtual space coordinate system).

Now back to FIG. 11, the first virtual space screen display control data 550 stores various types of data related to processing for generating an embodiment image 17 for each avatar 8, and for causing the user terminal 1500 to display a first virtual space screen W1.

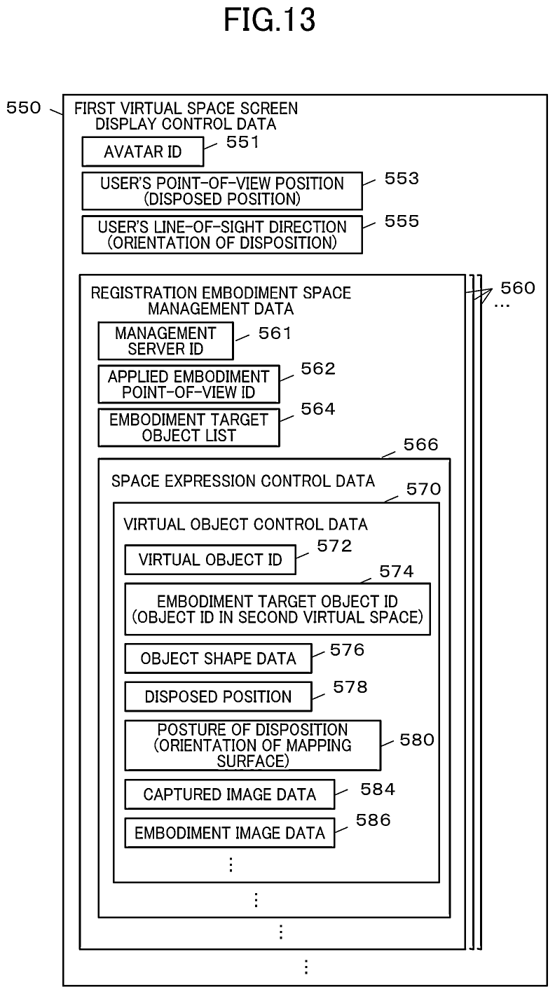

The first virtual space screen display control data 550 stores, for example, as illustrated in FIG. 13, an avatar ID 551 indicating which avatar 8 the data relates to, a user's point-of-view position 553 representing a position of the user's point of view C1 of the avatar 8 in the first virtual space 11, a user's line-of-sight direction 555 representing a line-of-sight direction of the user's point of view C1, and registration embodiment space management data 560.

The registration embodiment space management data 560 is created each time a new embodiment space 14 entering the field of view of the avatar 8 is detected, and stores various types of data related to the embodiment space 14. One piece of the registration embodiment space management data 560 includes a management server ID 561, an applied embodiment point-of-view ID 562, an embodiment target object list 564, and space expression control data 566.

The management server ID 561 indicates the sub-server system 1100G controlling and managing the second virtual space 12 serving as the source of the embodiment space 14.

The applied embodiment point-of-view ID 562 indicates the embodiment point of view C3 set in the second virtual space 12 for the sub-server system 1100G that the management server ID 561 indicates, that is, the embodiment point of view C3 of the avatar 8 that the avatar ID 551 indicates.

The embodiment target object list 564 is a list of object IDs of embodiment target objects in the second virtual space 12 embodied in the embodiment space 14. As a predetermined request is transmitted from the main server system 1100P to the sub-server system 1100G that the management server ID 561 indicates, provision of the embodiment target object list 564 is received from the sub-server system 1100G. The list serves as sources of virtual objects 15 (see FIG. 4) that should be set for the avatar 8 that the avatar ID 551 indicates.

The space expression control data 566 represents a group of pieces of data for controlling expression of the embodiment space 14.

For example, the space expression control data 566 includes virtual object control data 570 for each object in the embodiment target object list 564.

One piece of the virtual object control data 570 includes a unique virtual object ID 572, an embodiment target object ID 574 indicating a target embodied by each of the virtual objects 15, object shape data 576, a disposed position 578 in the first virtual space 11, a posture of disposition 580, captured image data 584 for an embodiment target object that the embodiment target object ID 574 indicates, and embodiment image data 586 with which texture mapping is performed onto each of the virtual objects 15.

The posture of disposition 580 indicates an orientation of each of the virtual objects 15. When a virtual object 15 has a plate-shaped polygon, a normal direction with respect to a mapping surface undergoing texture mapping is indicated.

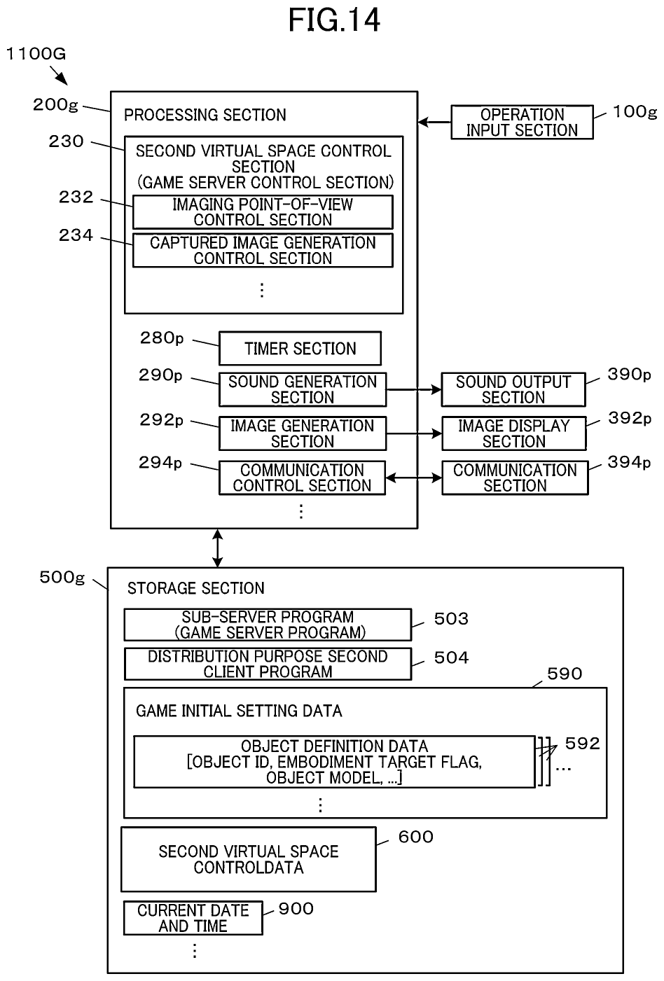

FIG. 14 is a block diagram illustrating a functional configuration example of the sub-server system 1100G (1100Ga, 1100Gb, . . . ). The sub-server system 1100G includes an operation input section 100g, a processing section 200g, a sound output section 390g, an image display section 392g, a communication section 394g, and a storage section 500g.

The operation input section 100g is a means for inputting various types of operations for managing the sub-server system 1100G. For example, the operation input section 100g corresponds to a keyboard, a touch panel, a mouse, or a VR controller.

The processing section 200g is implemented, for example, by a processor serving as a calculation circuit such as a CPU, a GPU, an ASIC, or an FPGA and an electronic component such as an IC memory, and performs input-and-output control for data among functional sections including the operation input section 100g and the storage section 500g. Various types of calculation processes are then executed based on a predetermined program and data, an operation input signal from the operation input section 100g, or data received from the user terminals 1500 and the main server system 1100P, for example, to comprehensively control operation of the sub-server system 1100G.

The processing section 200g includes a second virtual space control section 230, a timer section 280g, a sound generation section 290g, an image generation section 292g, and a communication control section 294g. Other functional sections may be included as appropriate, of course.

The second virtual space control section 230 performs various types of control related to the second virtual space 12. Since the second virtual space 12 is a game space, the second virtual space control section 230 implements a function as a game server. For example, various types of control related to participation registration control (play login) for a user (a second participating user) who is also a player, control for the player character 4, game progress control, control for an NPC, or management of a background object are executed. Then, the second virtual space control section 230 includes an imaging point-of-view control section 232 and a captured image generation control section 234.

The imaging point-of-view control section 232 sets an imaging point of view in the second virtual space 12, and controls its position or its line-of-sight direction (an orientation). Specifically, the imaging point-of-view control section 232 sets and controls the participating user's point of view C2 or the embodiment point of view C3 (see FIG. 7).

For the embodiment point of view C3, a position and/or an orientation of the embodiment point of view C3 for the avatar 8 is further controlled in accordance with the position and/or the orientation of the user's point of view C1 corresponding to the avatar 8 of the second participating user in the first virtual space 11. That is, as the avatar 8 moves in the first virtual space 11, and the position and the line-of-sight direction of the user's point of view C1 change, the embodiment point of view C3 undergoes trace control to cause the corresponding embodiment point of view C3 to similarly move in the second virtual space 12, and to cause its position and its line-of-sight direction to change.

The captured image generation control section 234 performs, for each embodiment point of view C3, control related to generation of a captured image 18 in which an embodiment target object is imaged (see FIG. 7).

The timer section 280g utilizes a system clock to perform various types of time measurements such as a current date and time or a limited time period.

The sound generation section 290g is implemented by an IC or through execution of software that generates sound data or performs decoding, and generates or decodes sound data of operational sounds, sound effects, background music (BGM), or voice speech, for example, related to system management of the sub-server system 1100G or provision of the online game. Then, a sound signal related to system management is outputted to the sound output section 390g. The sound output section 390g is implemented by a speaker, for example, and emits sound based on the sound signal.

The image generation section 292g generates images of various types of management screens for system management of the sub-server system 1100G, and outputs display control signals for displaying the generated images to the image display section 392g. The image display section 392g is implemented by a device for displaying an image, such as a flat panel display, a head-mounted display, or a projector.

Furthermore, the image generation section 292g performs generation of an image related to gameplay. For example, rendering of an image in which the second virtual space 12 is imaged from the participating user's point of view C2 (rendering processing) and generation of a second virtual space screen W2 to be displayed on each of the user terminals 1500 are performed (see FIG. 2).

Furthermore, the image generation section 292g performs rendering of an image (a captured image 18; see FIG. 7) in which the second virtual space 12 is imaged from the embodiment point of view C3 (rendering processing).

The communication control section 294g implements data exchange with an external device via the communication section 394g. The communication section 394g is coupled to the network 9 to implement communication. For example, the communication section 394g is implemented by a wireless communication device, a modem, a terminal adaptor (TA), a jack for wired communication cable, or a control circuit. In the example illustrated in FIG. 1, the communication device 1153 corresponds to the communication section 394g.

The storage section 500g stores, for example, programs and various types of data for implementing various types of functions for causing the processing section 200g to comprehensively control the sub-server system 1100G. Furthermore, the storage section 500g is used as a work area for the processing section 200g, and temporarily stores, for example, results of calculations executed by the processing section 200g in accordance with various types of programs. This function is implemented, for example, by an IC memory such as a RAM or a ROM, a magnetic disc such as a hard disk, an optical disc such as a CD-ROM or a DVD, or an online storage. In the example illustrated in FIG. 1, the IC memory 1152 mounted on the main body device or a storage medium such as a hard disk corresponds to the function. An online storage may be included in the storage section 500g.

The storage section 500g stores, for example, a sub-server program 503, a distribution purpose second client program 504, game initial setting data 590, second virtual space control data 600, and a current date and time 900. Other types of data may be included as appropriate, of course.

The sub-server program 503 is a program read and executed by the processing section 200g to cause the processing section 200g to function as the second virtual space control section 230. In the present embodiment, since the online game is implemented by using the second virtual space 12, the sub-server program 503 also serves as a game server program for implementing a function as a game server.

The distribution purpose second client program 504 is an original of an application program provided to and executed by the user terminals 1500 accessing the sub-server systems 1100G. Note that the distribution purpose second client program 504 may be included in the distribution purpose first client program 502 (see FIG. 11).

The game initial setting data 590 stores various types of initial setting data for the online game. For example, object definition data 592 is stored. The object definition data 592 is prepared for each object to be disposed in the second virtual space 12, and stores various types of initial setting data related to the object. For example, the object definition data 592 includes an object ID, an embodiment target flag that is set to “1” when the object is an embodiment target object, and an object model. Other types of data may be included as appropriate, of course.

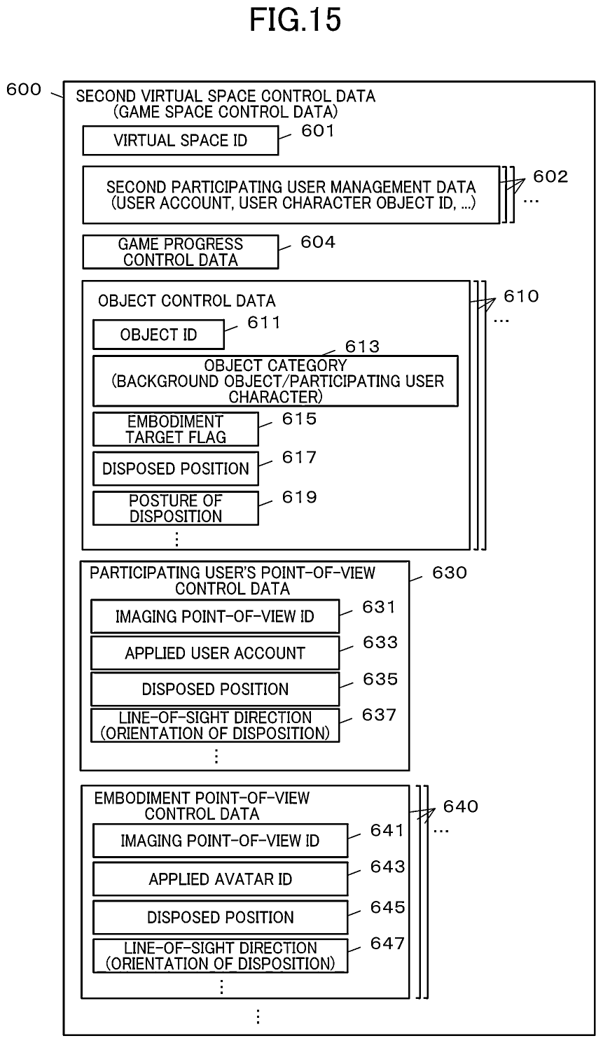

FIG. 15 is a diagram illustrating a data configuration example of the second virtual space control data 600.

The second virtual space control data 600 corresponds to control data for the game space, and includes, for example, a unique virtual space ID 601, second participating user management data 602, game progress control data 604, object control data 610, participating user's point-of-view control data 630, and embodiment point-of-view control data 640. Other types of data may be included as appropriate, of course.

The second participating user management data 602 is created each time a second participating user logs in for gameplay, and stores a user account and an object ID of a player character 4, for example.

The object control data 610 is created for each object disposed in the second virtual space 12, and stores various types of data related to the object. One piece of the object control data 610 includes, for example, an object ID 611, an object category 613 indicating whether the object is a background object or a player character 4, an embodiment target flag 615, a disposed position 617, and a posture of disposition 619. Other types of data such as motion control data may be included as appropriate, of course.

The participating user's point-of-view control data 630 is created for each participating user's point of view C2, and stores various types of data describing a latest state. The participating user's point-of-view control data 630 includes an imaging point-of-view ID 631, an applied user account 633 indicating the second participating user using the point of view, a disposed position 635 in the second virtual space 12, and a line-of-sight direction 637 (an orientation of disposition) in the second virtual space 12. Other types of data may be included as appropriate, of course.

The embodiment point-of-view control data 640 is created for each embodiment point of view C3, and stores various types of data related to the embodiment point of view C3. One piece of the embodiment point-of-view control data 640 includes an imaging point-of-view ID 641, an applied avatar ID 643 indicating the avatar 8 to which the point of view corresponds, a disposed position 645 in the second virtual space 12, and a line-of-sight direction 647 in the second virtual space 12. Other types of data may be included as appropriate, of course.

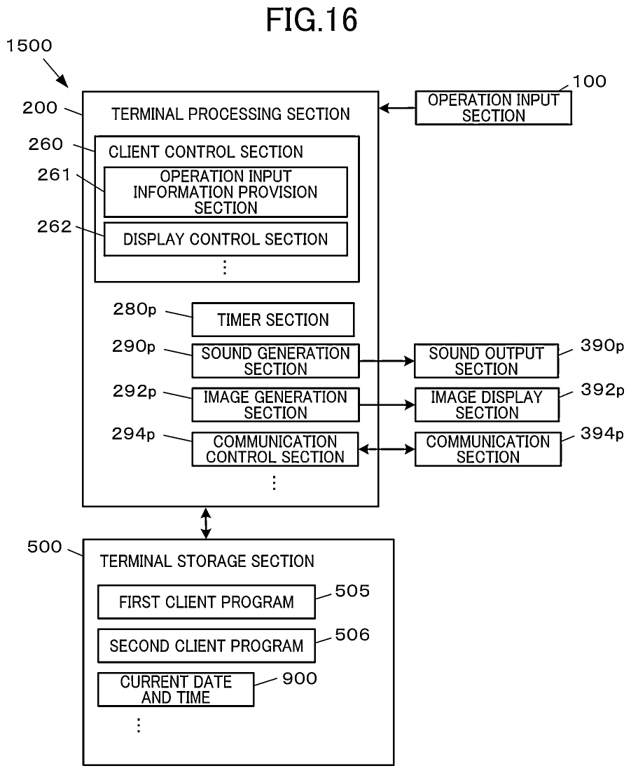

FIG. 16 is a functional block diagram illustrating a functional configuration example of the user terminal 1500. The user terminal 1500 includes an operation input section 100, a terminal processing section 200, a sound output section 390, an image display section 392, a communication section 394, and a terminal storage section 500.

The operation input section 100 outputs operation input signals in accordance with various types of operation inputs performed by the user to the terminal processing section 200. For example, the operation input section 100 is implemented by a push switch, a joystick, a touch pad, a track ball, an acceleration sensor, a gyro, or a VR controller.

The terminal processing section 200 is implemented, for example, by a microprocessor such as a CPU or a GPU and an electronic component such as an IC memory, and performs input-and-output control for data among functional sections including the operation input section 100 and the terminal storage section 500. Various types of calculation processes are then executed based on a predetermined program and data, an operation input signal from the operation input section 100, or various types of data received from the main server system 1100P and the sub-server systems 1100G to control operation of the user terminal 1500.

The terminal processing section 200 includes a client control section 260, a timer section 280, a sound generation section 290, an image generation section 292, and a communication control section 294.

The client control section 260 performs various types of control as a client or a game client in the virtual space control system 1000 to cause the user terminal 1500 to function as a man-machine interface (MMIF). Specifically, the client control section 260 includes an operation input information provision section 261 and a display control section 262.

The operation input information provision section 261 performs control for transmitting operation input information to the main server system 1100P and the sub-server systems 1100G in accordance with an input from the operation input section 100.

The display control section 262 performs control for displaying various types of images based on data received from the main server system 1100P and the sub-server systems 1100G.

The timer section 280 utilizes a system clock to perform time measurements such as a current date and time or a limited time period.

The sound generation section 290 is implemented, for example, by a digital signal

processor (DSP) or a processor such as a sound synthesizing IC and an audio codec that makes it possible to play a sound file, generates sound signals of music, sound effects, or various types of operational sounds, and outputs the generated sound signals to the sound output section 390. The sound output section 390 is implemented by a device that outputs sound (emits sound) based on the sound signals inputted from the sound generation section 290, such as a speaker.

The image generation section 292 outputs a display control signal causing the image display section 392 to display an image based on control of the client control section 260. In the example illustrated in FIG. 1, a graphics processing unit (GPU), a graphic controller, or a graphic board mounted on the control board 1550 corresponds to the image generation section 292. The image display section 392 is implemented by a device for displaying the image, such as a flat panel display, a display element of a VR headset, or a projector.

The communication control section 294 executes data processing related to data communication, and implements data exchange with an external device via the communication section 394.

The communication section 394 is coupled to the network 9 to implement communication. For example, the communication section 394 is achieved by a wireless communication device, a modem, a terminal adaptor (TA), a jack for wired communication cable, or a control circuit. In the example illustrated in FIG. 1, the communication module 1553 corresponds to the communication section 394.

The terminal storage section 500 stores programs and various types of data for causing the terminal processing section 200 to implement given functions. Furthermore, the terminal storage section 500 is used as a work area for the terminal processing section 200, and temporarily stores results of calculations executed by the terminal processing section 200 in accordance with various types of programs or input data inputted from the operation input section 100. These functions are implemented, for example, by an IC memory such as a RAM or a ROM, a magnetic disc such as a hard disk, or an optical disc such as a CD-ROM or a DVD. In the example illustrated in FIG. 1, the IC memory 1552 mounted on the control board 1550 corresponds to the terminal storage section 500.

Specifically, the terminal storage section 500 stores a first client program 505 (an application program), a second client program 506 (an application program), and a current date and time 900. Other types of data may be stored as appropriate, of course. For example, a token, a flag, a timer, or a counter is also stored.

The first client program 505 is a program for implementing a function as the client control section 260 for utilizing the first virtual space 11, and is acquired from the main server system 1100P.

The second client program 506 is a program for implementing a function as the client control section 260 for utilizing the second virtual space 12, and is acquired from the sub-server system 1100G.

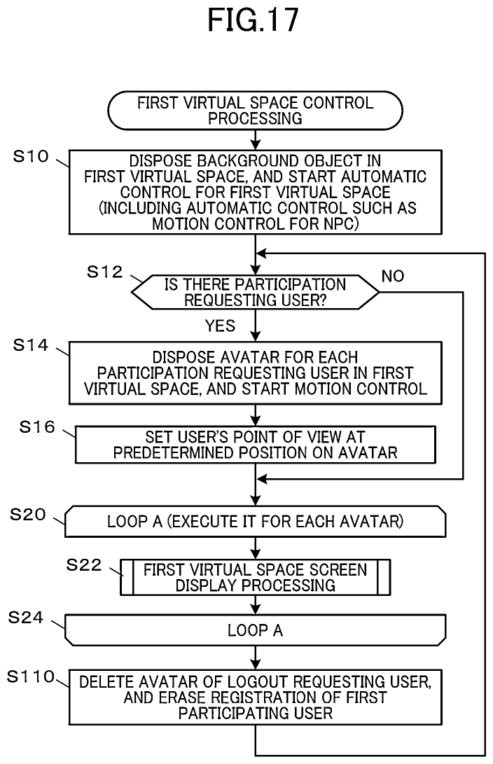

FIG. 17 is a flowchart illustrating a flow of first virtual space control processing that the main server system 1100P executes.

In the processing, the main server system 1100P disposes a background object in the first virtual space 11, and starts automatic control for the first virtual space 11 (step S10). For example, automatic control for motion of a non-player character (NPC) or occurrence of an event is started.

The main server system 1100P communicates with the user terminal 1500 executing the first client program 505, and as a predetermined system login is received, determines that there is a participation requesting user (YES in step S12), and regards the user who has system-logged in as a new first participating user. Then, avatar management data 524 is created for the new first participating user, an avatar 8 of the user is disposed in the first virtual space 11, and motion control for the avatar 8 in accordance with an operation input performed by the participating user is started (step S14). Then, the user's point of view C1 of the avatar 8 that has been newly disposed is set at a predetermined position on the avatar 8 (step S16). After that, the user's point of view C1 undergoes automatic control in a linked manner to the position and the orientation of the head of the avatar 8 in accordance with motion control for the avatar 8.

Next, the main server system 1100P executes a loop A for each avatar 8, and executes first virtual space screen display processing for each avatar 8 (from step S20 to step S22).

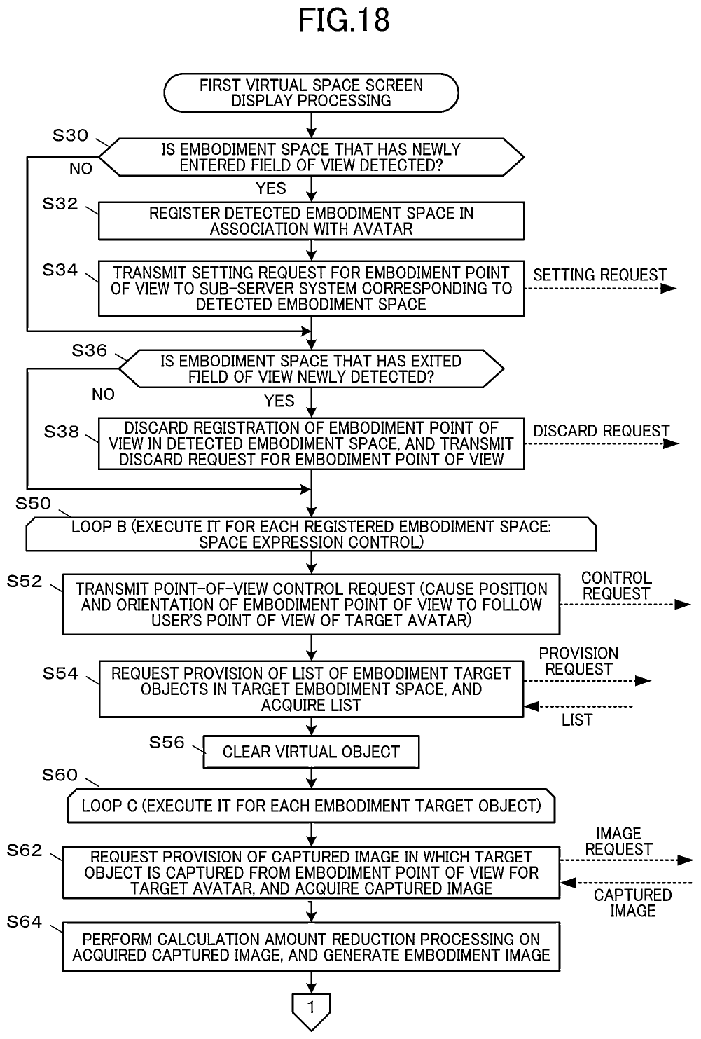

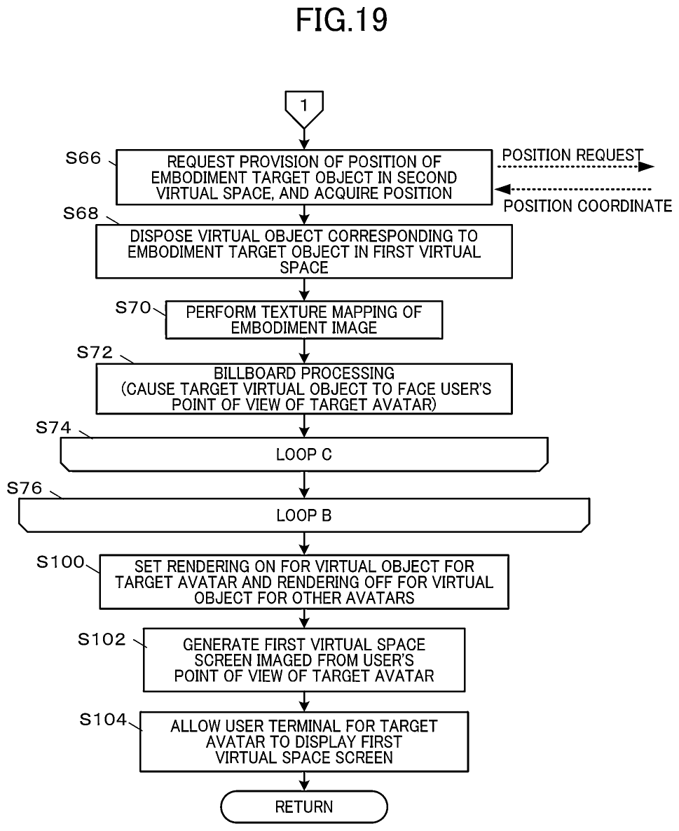

FIGS. 18 to 19 are a flowchart illustrating a flow of the first virtual space screen display processing. In the processing, as an embodiment space 14 that has entered a field-of-view range of the avatar 8 (the target avatar) that is a processing target for the loop A has been newly detected (YES in step S30), the main server system 1100P creates registration embodiment space management data 560 (see FIG. 13) for the detected embodiment space 14, and registers the embodiment space 14 in association with the target avatar (step S32).

Next, the main server system 1100P refers to the embodiment space management data 540 (see FIG. 12) of the detected embodiment space 14, and transmits a predetermined setting request to the sub-server system 1100G that the management server ID 541 indicates (step S34).

Specifically, information of a disposed position and a line-of-sight direction of the embodiment point of view C3, which is requested to be set in the second virtual space 12 for the transmission destination, that is, the sub-server system 1100G, is transmitted. The disposed position and the line-of-sight direction of the embodiment point of view C3 in the second virtual space 12 are acquired by converting the user's point-of-view position 553 and the user's line-of-sight direction 555 (see FIG. 13) of the target avatar based on the coordinate transformation definition data 544 (see FIG. 12) of the detected embodiment space 14.

When an embodiment space 14 that has exited the field of view, among the embodiment spaces 14 registered in relation to the target avatar, has been newly detected (YES in step S36), on the other hand, the main server system 1100P discards the registration of the detected embodiment space 14, and requests for discarding of the embodiment point of view C3 (step S38). Specifically, the registration embodiment space management data 560 (see FIG. 13) is deleted, and a discard request for the predetermined embodiment point of view is transmitted, together with the avatar ID 551 of the target avatar, to the sub-server system 1100G corresponding to the detected embodiment space 14.

Next, the main server system 1100P executes a loop B for each embodiment space registered in relation to the target avatar (from step S50 to step S76).

During the loop B, the main server system 1100P transmits a predetermined control request to the sub-server system 1100G managing the second virtual space 12 serving as the source of the registered embodiment space (the target embodiment space) regarded as the processing target (step S52).

A “control request” is for requesting the sub-server system 1100G for performing control for causing the position and the line-of-sight direction of the embodiment point of view C3 of the target avatar in the second virtual space 12 to follow, in a linked manner, a latest state of the position and the line-of-sight direction of the user's point of view C1 of the target avatar in the first virtual space 11. Together with the request, the avatar ID 551 of the target avatar, a destination position of change, and a line-of-sight direction after changed are transmitted. The destination position of change and the line-of-sight direction after changed are acquired by converting the disposed position and the line-of-sight direction of the user's point of view C1 of the target avatar in the first virtual space coordinate system based on the coordinate transformation definition data 544 of the target embodiment space.

Next, the main server system 1100P transmits a provision request for requesting provision of a list of the embodiment target objects in the target embodiment space, together with the avatar ID 551 of the target avatar, to the sub-server system 1100G managing the second virtual space 12 serving as the source of the target embodiment space, and acquires a list (step S54). The embodiment target object list 564 is updated with the received list (see FIG. 13).

Next, the main server system 1100P deletes the virtual object control data 570 (see FIG. 13) of the target embodiment space, and once clears the setting of the virtual objects 15 (step S56), and then executes a loop C for each latest embodiment target object in the target embodiment space. The main server system 1100P disposes again the virtual objects 15 in accordance with the latest situation of the embodiment target object in the second virtual space 12, which the embodiment target object list 564 indicates (from step S60 to step S74).

During the loop C, the main server system 1100P transmits a predetermined image request for requesting provision of a captured image 18 (see FIG. 7) in which each embodiment target object (the target object) regarded as a processing target for the loop C is imaged from the embodiment point of view C3 of the target avatar to the sub-server system 1100G managing the second virtual space 12 serving as the source of the target embodiment space, and acquires the image (step S62). Together with the image request, the avatar ID 551 of the target avatar and the embodiment target object ID 574 of the target object are further transmitted. The image received from the sub-server system 1100G is treated as captured image data 584 (see FIG. 13).

Next, the main server system 1100P performs calculation amount reduction processing on the received captured image 18 to generate an embodiment image 17 (step S64).

Now move to FIG. 19, the main server system 1100P transmits a predetermined position request for requesting provision of a latest disposed position of each embodiment target object in the second virtual space 12 to the sub-server system 1100G managing the second virtual space 12 serving as the source of the target embodiment space, together with the embodiment target object ID 574 of the target object, and acquires the position (step S66). A received position coordinate is converted by using an inverse matrix in the coordinate transformation definition data 544 for the target embodiment space, and a result is treated as a disposed position 578 of each virtual object 15 of the embodiment target object (see FIG. 13).

Then, the main server system 1100P determines a size and a shape of each virtual object 15 of the target object, and disposes the object in the first virtual space 11 (step S68).

Specifically, the size and the shape of each virtual object 15 are set as a size and a shape of a rectangular having an identical upper-lower width and an identical left-right width to those of the received captured image 18 or the generated embodiment image 17, which are set as object shape data 576, and the virtual object 15 in accordance with the setting data is disposed at the position of disposition 578.

Then, the main server system 1100P performs texture mapping of the embodiment image 17 onto the disposed virtual object 15 (step S70), and performs the billboard processing for causing the mapping surface of the virtual object 15 to face the user's point of view C1 of the target avatar (step S72).

Note that the billboard processing may be omitted as appropriate in accordance with a relative positional relationship between, and relative orientations of, a virtual object 15 of the embodiment target object and the user's point of view C1 of a target avatar. For example, the billboard processing may be omitted for a virtual object 15 of an embodiment target object, which is away from the user's point of view C1 at a predetermined distance or longer. Furthermore, the billboard processing may be omitted when a difference between the orientation of the line-of-sight direction of the user's point of view C1 and the normal direction with respect to the mapping surface of a virtual object 15 falls within an allowable angle range. Therefore, it is possible to reduce a process load in the main server system 1100P.

After the loop C has been executed for all the embodiment target objects, and the virtual objects 15 corresponding to the embodiment target objects have been disposed in the virtual space 13 (step S74), a next registered embodiment space is regarded as a target embodiment space, and the loop B is repeated.

After the loop B has been executed for all the registered embodiment spaces (step S76), the main server system 1100P sets rendering ON for the virtual objects 15 for the target avatar, and rendering OFF for the virtual objects 15 of other avatars (step S100). Next, the main server system 1100P renders an image of the first virtual space 11, which is captured from the user's point of view C1 of the target avatar, adds information display, for example, as appropriate, to the image, and generates a first virtual space screen W1 (step S102).

Then, the user terminals 1500 for the target avatars are allowed to display the first virtual space screen W1 (step S104). The first virtual space screen display processing for the target avatars ends.

Now back to FIG. 17, as a predetermined system logout is received from the user terminal 1500 of the first participating user, the main server system 1100P deletes the avatar 8 of the user from the first virtual space 11. Then, the main server system 1100P deletes the avatar management data 524 and the first virtual space screen display control data 550, and erases the participation registration of the first participating user (step S110).

The main server system 1100P repeats and executes step S12 to step S110.

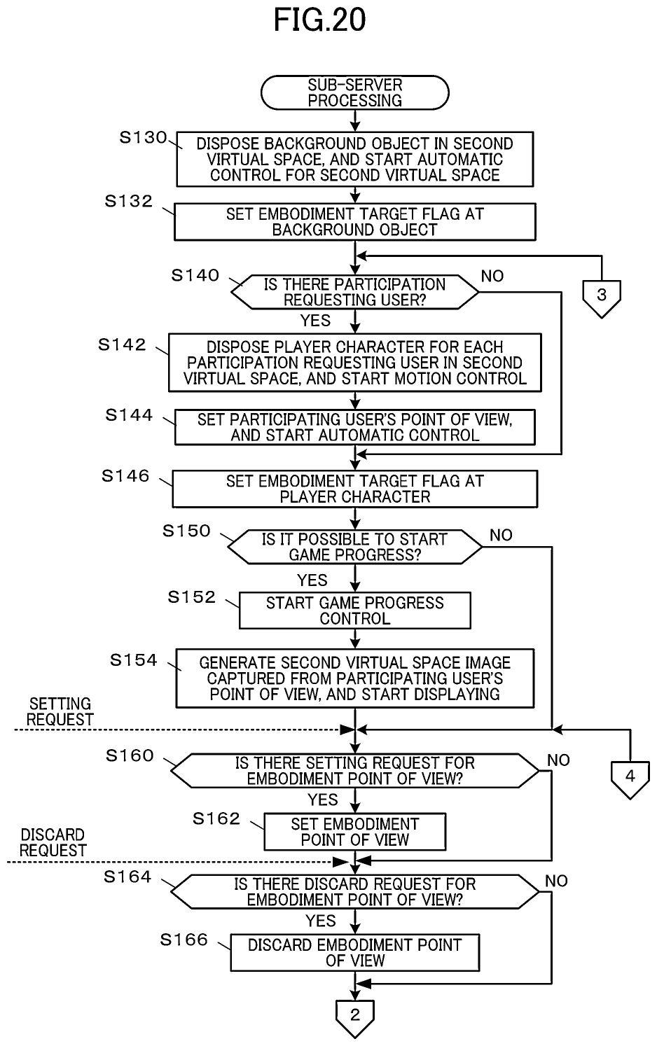

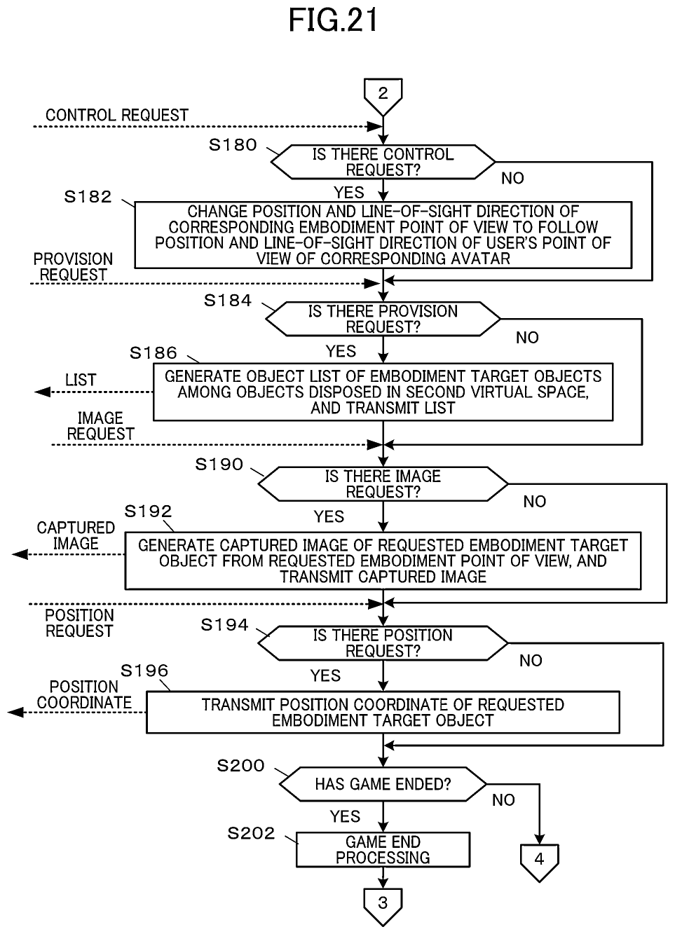

FIGS. 20 to 21 are a flowchart illustrating a flow of processing that the sub-server system 1100G executes.

The sub-server system 1100G refers to the game initial setting data 590, disposes background objects forming a game space in the second virtual space 12, and starts automatic control for the second virtual space 12 (step S130). Then, the sub-server system 1100G raises an embodiment target flag 615 (see FIG. 15) at the object where an embodiment target flag is raised in the object definition data 592 among the disposed background objects (step S132).

The sub-server system 1100G communicates with the user terminals 1500 executing the second client program 506, and, as a login for gameplay is received, determines that there is a participation requesting user (YES in step S140). The sub-server system 1100G regards the user who has play-logged in as a new second participating user, disposes its player character 4 in the second virtual space 12, and starts motion control in accordance with an operation input performed by the new second participating user (step S142).

Next, the sub-server system 1100G sets the participating user's point of view C2 (the imaging point of view) at a predetermined position on the newly disposed player character 4, and starts automatic control for causing a position and a line-of-sight direction of the point of view to follow a change in position or orientation of the player character 4 (step S144). The sub-server system 1100G raises the embodiment target flag 615 at the player character 4 (step S146).

In the present embodiment, since the one-on-one battle fighting game where two players fight in the second virtual space 12 is executed, the participating user's point of view C2 is shared. However, the participating user's point of view C2 is set for each player character 4 depending on a game genre. Furthermore, although, in the present embodiment, a player character 4 is set as an embodiment target object with no condition, all player characters 4 may not necessarily be set as embodiment target objects in another game such as a massively multiplayer online role playing game (MMORPG). For example, in the step, some embodiment target objects may be extracted from among the player characters 4 already disposed in the second virtual space 12.

Next, the sub-server system 1100G determines whether it has been possible to start game progress control (step S150). Since, in the present embodiment, the one-on-one battle fighting game where two players fight in the second virtual space 12 is executed, making an affirmative determination when two second participating users join (YES in step S150) starts game progress control (step S152). The sub-server system 1100G starts, as the game progress control, control for generating an image of the second virtual space 12, which is captured from the participating user's point of view C2, and for allowing the user terminals 1500 of the second participating users to display a second virtual space screen W2 (see FIG. 3).

Note that, when a genre of a game executed in the second virtual space 12 is a multiplayer online role playing game (MORPG), for example, step S150 to step S154 may be executed, together with step S142 and step S144.

The sub-server system 1100G sets, as a setting request is received from the main server system 1100P (YES in step S160), the embodiment point of view C3 in the second virtual space 12 (step S162).

Furthermore, the sub-server system 1100G deletes and discards, as a discard request is received from the main server system 1100P (YES in step S164), the requested embodiment point of view C3 from the second virtual space 12 (step S166).

Now move to FIG. 21, the sub-server system 1100G performs, as a control request is received from the main server system 1100P (YES in step S180), change control for causing the position and the line-of-sight direction of the requested embodiment point of view C3 to follow a change in position or line-of-sight direction of the user's point of view C1 of the avatar 8, which corresponds to the embodiment point of view C3 (step S182).

Furthermore, the sub-server system 1100G searches and retrieves, as a provision request is received from the main server system 1100P (YES in step S184), the objects where the embodiment target flag 615 is “1 (flag is raised)” from among the objects disposed in the second virtual space 12. Then, the sub-server system 1100G transmits a list of the object IDs 611 of the objects to the main server system 1100P (step S186).

Furthermore, the sub-server system 1100G generates, as an image request is received from the main server system 1100P (YES in step S190), a captured image 18 in which the requested embodiment target object is captured from the requested embodiment point of view C3, and transmits the generated image to the main server system 1100P (step S192).

Furthermore, the sub-server system 1100G transmits, as a position request is received from the main server system 1100P (YES in step S194), the position coordinate of the requested embodiment target object to the main server system 1100P (step S196).

As a game end condition is satisfied (YES in step S200), the sub-server system 1100G executes game end processing (step S202). For example, the player character 4 of the second participating user is deleted from the second virtual space 12. In a case of a tournament type battle game, a player character 4 of a winner may not be deleted.

As described above, according to the present embodiment, it is possible to provide a technique for a new embodiment method making a situation where as if a second virtual space exists in a first virtual space.

The virtual space control system 1000 sets a virtual space 13 in the first virtual space 11, and expresses an embodiment space 14 embodying the second virtual space 12 in the virtual space 13. At that time, a virtual object 15 embodying an embodiment target object in the second virtual space 12 is only disposed in the virtual space 13. That is, it is possible to embody a situation of the second virtual space 12 in the first virtual space 11 with a far smaller calculation amount, far lesser processing steps, and a far smaller data amount, compared with a case where all objects disposed in the second virtual space 12 are replicated in the first virtual space 11, and motion control is performed similar or identical to that for the sources of replication.

In addition, aligning a disposition configuration of virtual objects 15 with a disposition configuration of embodiment target objects in the second virtual space 12, which are associated with the virtual objects, makes it possible to express, in the first virtual space 11, the situation of the second virtual space 12 in a similar manner to a live play.

Then, since captured images 18 serving as sources of embodiment images 17 with which texture mapping is to be performed onto the virtual objects 15 are generated in the sub-server systems 1100G, it is possible to suppress a process load, which is related to expression of the embodiment spaces 14, in the main server system 1100P. In addition, since embodiment images 17 are created by performing the calculation amount reduction processing on the captured images 18, it is possible to further suppress the process load in the main server system 1100P.

### MODIFICATION EXAMPLES

An example of the embodiment to which the present disclosure is applied has been described so far. Note that the present disclosure is not limited to the foregoing embodiment.

Various modifications may be made as appropriate, such as adding other elements, omitting some of the elements, or changing some of the elements.

### Modification Example 1

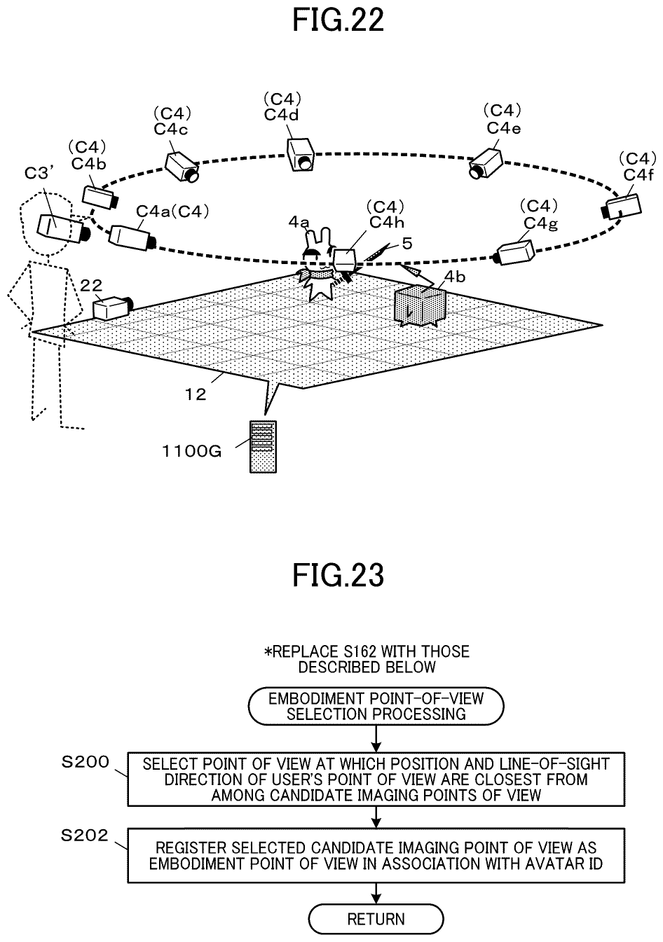

For example, although, in the embodiment described above, the embodiment point of view C3 has been set in the second virtual space 12 for each avatar 8, the present disclosure is not limited to the embodiment. For example, as illustrated in FIG. 22, a plurality of candidate imaging points of view C4 (C4a, C4b, . . . ) may be set in advance in the second virtual space 12, and the embodiment point of view C3 may be selected from among the candidates.

Although it is possible to set a number of the candidate imaging points of view C4 as appropriate, for example, approximately 100 imaging points of view may be set for imaging embodiment target objects (in the example illustrated in FIG. 22, a player character 4a, a player character 4b, and an item 5) from all directions. For each of the candidate imaging points of view C4, a relative position and a line-of-sight direction are set to image the embodiment target objects (in the example illustrated in FIG. 22, the player character 4a, the player character 4b, and the item 5) at each position in a given screen layout.

An avatar's point of view C3′ in FIG. 22 is a point of view based on a position coordinate and a line-of-sight direction that the sub-server system 1100G has received together with a setting request. With the embodiment described above, the avatar's point of view corresponds to the embodiment point of view C3 set in step S162 (see FIG. 20).

In the modification example, the sub-server system 1100G executes a flow of embodiment point-of-view selection processing illustrated in FIG. 23, instead of step S162. That is, the sub-server system 1100G selects a candidate imaging point of view C4 (in the example illustrated in FIG. 23, the candidate imaging point of view C4a) at which a position coordinate and a line-of-sight direction are closest, which are received together with a setting request, from among the candidate imaging points of view C4 (step S200), and registers the candidate imaging point of view C4 as the embodiment point of view C3 of the target avatar (step S202).

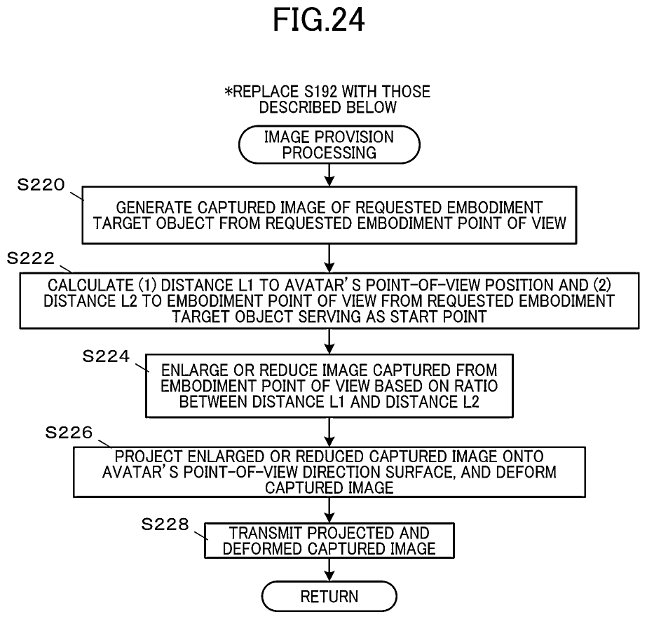

Furthermore, in the modification example, the sub-server system 1100G executes a flow of image provision processing illustrated in FIG. 24, instead of step S192 (see FIG. 21).

That is, the sub-server system 1100G generates a captured image 18 of an embodiment target object requested to be imaged from the embodiment point of view C3 of the avatar 8 requested by an image request (step S220). Next, the sub-server system 1100G regards a representative point of the requested embodiment target object as a start point, (1) calculates a distance L1 from the start point to the avatar's point of view C3′ and a distance L2 from the start point to the embodiment point of view C3 (step S224), and performs enlarging-or-reducing processing on the previously generated captured image 18 based on a ratio between the distance L1 and the distance L2. When the avatar's point of view C3′ is farther than the embodiment point of view C3 from the requested embodiment target object, the captured image 18 is reduced in accordance with the ratio, or, in an opposite case, is enlarged in accordance with the ratio.

Next, the sub-server system 1100G performs projection conversion processing on the enlarged or reduced captured image 18 onto a normal surface (a surface where the line-of-sight direction serves as a normal direction) of the avatar's point of view C3′ (step S226), and transmits the enlarged or reduced captured image having undergone the processing to the main server system 1100P as the captured image 18 (step S228).

### Modification Example 2

Furthermore, in the embodiment described above, although a virtual object 15 is created for each embodiment target object, such a configuration may be applied that all embodiment target objects are expressed as one virtual object 15 in a case where the participating user's point of view C2 accommodates all the embodiment target objects within its imaging range.

### Modification Example 3

Furthermore, in the embodiment described above, although an example where a player character 4 serves as an embodiment target object has been described, objects for various types of effect display such as luster, explosive smoke, fog, spark, and concentrated line work may serve as embodiment target objects as appropriate.

### Modification Example 4

Furthermore, although, in the embodiment described above, a plate-shaped polygon has been exemplified as a virtual object 15, the present disclosure is not limited to the embodiment. For example, a virtual object 15 may be created as a three-dimensional model having a plurality of polygons by using photogrammetry based on captured images 18 captured from the candidate imaging points of view C4. Specifically, the main server system 1100P may acquire, from the sub-server systems 1100G, captured images 18 from all the candidate imaging points of view C4 as photogrammetry raw-material images, instead of the loop C, execute photogrammetry processing on the acquired captured images 18 as raw materials, and create virtual objects 15. In this case, it is not necessary to execute the billboard processing (step S72 illustrated in FIG. 19) on the virtual objects 15.

### Modification Example 5

Furthermore, although an example where both a position and a line-of-sight direction are controlled in each virtual space in relation to various types of points of view (the user's point of view C1, the participating user's point of view C2, the embodiment point of view C3, and a candidate imaging point of view) has been described, the present disclosure is not limited to the embodiment. Depending on (a) main expression targets in the first virtual space 11 and the second virtual space 12, (b) content of game implemented in the second virtual space 12, (c) design of an avatar 8 and a player character 4, and (d) shape of a virtual object 15, for example, such a configuration may be applied that either a position or a line-of-sight direction is controlled. Furthermore, step S66 may be omitted for an object at a fixed position in the second virtual space 12 (for example, a background object of a certain type).

### Modification Example 6

In relation to step S30 and step S36 (see FIG. 18), whether an embodiment space 14 enters the field of view of an avatar 8 differs depending on the position or the orientation (the line-of-sight direction) of the user's point of view C1 in the first virtual space 11. Whether only the position of the user's point of view C1 changes, only the line-of-sight direction changes, or both change differs depending on the content of (a) to (d) described above.

Furthermore, for control for a movement and an orientation of a virtual object 15 in accordance with a change in movement or direction of the user's point of view C1, whether only the movement is controlled, only the orientation is controlled, or both are controlled also differs depending on the content of (a) to (d) described above.

That is, in relation to step S72, it can be said that the main server system 1100P controls the position and/or the orientation of a virtual object 15 in accordance with the position and/or the orientation of the user's point of view C1 in the first virtual space 11.

Control for the embodiment point of view C3 in the second virtual space 12 is similar to those described above.

That is, whether only the position of the user's point of view C1 changes, only the line-of-sight direction changes, or both change differs depending on the content of (a) to (d) described above. Furthermore, whether only the movement of the embodiment point of view C3 is controlled, only the orientation is controlled, or both are controlled also differs depending on the content of (a) to (d) described above.

That is, it can be said that the sub-server system 1100G controls, in relation to step S182, the position and/or the orientation of the embodiment point of view C3 in the second virtual space in accordance with the position and/or the orientation of the user's point of view C1 in the first virtual space 11.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

1. A computer system comprising at least one processor or circuit programmed to execute:
setting a virtual space for expressing a given embodiment space in a first virtual space; and
disposing an object in the virtual space based on information of an object in a second virtual space, and performing space expression control for expressing the embodiment space embodying the second virtual space.

2. The computer system as defined in claim 1, wherein performing the space expression control includes disposing, in the virtual space, an object corresponding to the object in the second virtual space in a disposition configuration based on a disposition configuration in the second virtual space to perform control for expressing the embodiment space.

3. The computer system as defined in claim 1, wherein performing the space expression control includes expressing the second virtual space at a calculation amount smaller than a calculation amount when completely reproducing the second virtual space.

4. The computer system as defined in claim 1, wherein performing the space expression control includes performing control for expressing the embodiment space based on a captured image in which the second virtual space is imaged from a given imaging point of view.

5. The computer system as defined in claim 4, wherein performing the space expression control includes:
disposing a virtual object within a field of view of a given user's point of view in the first virtual space; and
performing, based on the user's point of view, rendering processing for rendering the virtual object onto which mapping of an image based on the captured image has been performed.

6. The computer system as defined in claim 5, wherein performing the space expression control includes performing virtual object control for controlling a position and/or an orientation of the virtual object in accordance with a position and/or an orientation of the user's point of view in the first virtual space.

7. The computer system as defined in claim 6, wherein performing the virtual object control includes performing control for disposing the virtual object at a posture at which a predetermined relative orientation is taken with respect to the user's point of view to follow a change in position and/or a change in orientation of the user's point of view.

8. The computer system as defined in claim 5, wherein
the imaging point of view includes a plurality of imaging points of view where disposed positions and/or orientations of disposition in the second virtual space differ from each other, and
performing the space expression control includes performing control for expressing the embodiment space based on a captured image captured from one imaging point of view among the plurality of imaging points of view.

9. The computer system as defined in claim 5, wherein the at least one processor or circuit is further programmed to execute imaging point-of-view control for controlling a position and/or an orientation of the imaging point of view in the second virtual space in accordance with a position and/or an orientation of the user's point of view in the first virtual space.

10. The computer system as defined in claim 9, wherein
performing the space expression control includes expressing the embodiment space by associating a coordinate of the virtual space in the first virtual space and a coordinate of the second virtual space with each other to express the embodiment space in which the second virtual space is fixedly embodied in the virtual space, and
performing the imaging point-of-view control includes controlling the position and/or the orientation of the imaging point of view in the second virtual space to follow a change in position and/or a change in orientation of the user's point of view with respect to the virtual space.

11. The computer system as defined in claim 5, wherein performing the space expression control includes disposing, for each of participating users participating in the first virtual space, the user's points of view corresponding to the participating users, performing the rendering processing, and performing control for expressing the embodiment space viewed from each of the user's points of view.

12. The computer system as defined in claim 11, wherein
a plurality of the second virtual spaces exist,
setting the virtual space includes setting the virtual space for each of the second virtual spaces in the first virtual space, and
performing the space expression control includes performing, for each of the participating users, the rendering processing for each of the virtual spaces within the field of view of the user's point of view corresponding to each of the participating users.

13. The computer system as defined in claim 4, wherein the imaging point of view and a participating user's point of view for each of the users participating in the second virtual space differ from each other.

14. The computer system as defined in claim 1, wherein the second virtual space is a game space for which game progress is controlled based on an operation input of a user participating in the second virtual space.

15. The computer system as defined in claim 1, wherein a computer for controlling the first virtual space and a computer for controlling the second virtual space are individually configured and provided.

16. A virtual space control system comprising:
a server system that is the computer system as defined in claim 1; and
a user terminal serving as a man-machine interface for a user participating in the first virtual space.

17. A virtual space control method executed by a computer system, the virtual space control method comprising:
setting a virtual space for expressing a given embodiment space in a first virtual space; and
disposing an object in the virtual space based on information of an object in a second virtual space, and performing control for expressing the embodiment space embodying the second virtual space.
